(19) United States
(12) Patent Application Publication
(10) Pub. No.: US 2024/0256693 A1
(43) Pub. Date: Aug. 1, 2024

(54) SECURITY SYSTEM REMOTE DEVICE ACCESS TRANSPARENCY

(71) Applicant: SimpliSafe, Inc., Boston, MA (US)

(72) Inventors: Joey Wong, Foster City, CA (US); Zachary William Rose, Natick, MA (US); Bojan Rajkovic, Salem, MA (US)

(21) Appl. No.: 18/446,283

(22) Filed: Aug. 8, 2023

Related U.S. Application Data
(60) Provisional application No. 63/482,340, filed on Jan. 31, 2023.

(51) Int. Cl. G06F 21/62; G08B 25/00

(52) U.S. Cl. CPC G06F 21/6218; G08B 25/001; G06F 2221/2141

(57) ABSTRACT

A method of recording security system events includes receiving an alarm signal from a device configured to communicate data generated by at least one camera in a monitored location. In response to receiving the alarm signal, a remote monitoring session during which a monitoring agent gains temporary access to video generated by the at least one camera begins. During the remote monitoring session, the monitoring agent accesses a video feed via the at least one camera. In response to accessing the video feed, a begin camera access event is logged to a user-accessible log. In response to ending the remote monitoring sessions, an end camera access event is logged to the user-accessible log.

### CROSS REFERENCE TO RELATED APPLICATIONS

This application claims priority under 35 U.S.C. § 119(e) to U.S. Provisional Application Ser. No. 63/482,340, titled “SECURITY SYSTEM REMOTE DEVICE ACCESS TRANSPARENCY,” filed Jan. 31, 2023, which is hereby incorporated herein by reference in its entirety.

### TECHNICAL FIELD

The present disclosure relates generally to security systems and methods, and more particularly to techniques for security system remote device access transparency.

### BACKGROUND

Systems for securing property typically include devices designed to detect the presence of persons in or around residential or commercial structures. Such devices include one or more cameras for obtaining live or recorded still images or video. The cameras are installed at strategic locations near entryways or other areas to be monitored for activity. Some security systems have the capability to transmit camera images to a remote location for monitoring and review by an entity that provides security monitoring services on behalf of the property owner.

### SUMMARY

At least one example is directed to a method including establishing, by remote computing device and in response to an alarm signal, a remote session with a camera, the remote session enabling a remote user to access video and audio data of the camera, and the access including streaming of video data for a location monitored by the camera and bi-directional communications between persons at the location and the remote user; generating, during the remote session, one or more events representative of actions of the remote user to access the camera; and providing notifications about the one or more events to a client device, the notifications including an indication that the remote user accessed the camera.

Another example is directed to a system of computing devices, the system includes at least one computing device. The computing device includes a memory; and at least one processor coupled with the memory. The at least one processor is configured to establish, in response to an alarm signal, a remote session with a camera, the remote session enabling a remote user to access video and audio data of the camera, and the access including streaming of video data for a location monitored by the camera and bi-directional communications between persons at the location and the remote user; generate, during the remote session, one or more events representative of actions of the remote user to access the camera; and provide notifications about the one or more events to a client device, the notifications including an indication that the remote user accessed the camera.

Another example is directed to one or more computer readable media storing sequences of instructions executable to report security system events. The sequences of instructions include instructions to receive an alarm signal from a device configured to communicate data generated by at least one camera in a monitored location; begin, in response to receiving the alarm signal, a remote monitoring session during which a monitoring agent gains temporary access to video generated by the at least one camera; access, by the monitoring agent and during the remote monitoring session, a video feed via the at least one camera; log, to a user-accessible log and in response to accessing the video feed, a begin camera access event; end the remote monitoring session; and log, to the user-accessible log and in response to ending the remote monitoring sessions, an end camera access event.

### BRIEF DESCRIPTION OF THE DRAWINGS

Additional examples of the disclosure, as well as features and advantages thereof, will become more apparent by reference to the description herein taken in conjunction with the accompanying drawings which are incorporated in and constitute a part of this disclosure. The figures are not necessarily drawn to scale.

FIG. 1 is a schematic diagram of a security system, according to some examples described herein.

FIG. 2 is a schematic diagram of a base station, according to some examples described herein.

FIG. 3 is a schematic diagram of a keypad, according to some examples described herein.

FIG. 4A is a schematic diagram of a security sensor, according to some examples described herein.

FIG. 4B is a schematic diagram of an image capture device, according to some examples described herein.

FIG. 5 is a schematic diagram of a data center environment, a monitoring center environment, and a customer device, according to some examples described herein.

FIG. 6 is a sequence diagram of a monitoring process, according to some examples described herein.

FIG. 7 shows further aspects of the monitoring center environment of FIGS. 1 and 5, one of the customer devices of FIG. 1, one of the monitored locations of FIG. 1, and the data center environment of FIGS. 1 and 5, according to some examples described herein.

FIG. 8 is a flow diagram of a process for security system event monitoring, according to some examples described herein.

FIG. 9 shows a graphical user interface for displaying remote monitoring events that have been logged according to the process of FIG. 8, according to some examples described herein.

FIG. 10 is a schematic diagram of a computing device, according to some examples described herein.

FIGS. 11-15 show several graphical user interfaces for displaying remote monitoring events that have been logged according to the process of FIG. 8, according to some examples described herein.

FIGS. 16-20 show a handheld device with several graphical user interfaces for displaying remote monitoring events that have been logged according to the process of FIG. 8, according to some examples described herein.

FIGS. 21-23 show several graphical user interfaces for displaying remote monitoring events that have been logged according to the process of FIG. 8, according to some examples described herein.

FIGS. 24-26 show a handheld device with several graphical user interfaces for displaying remote monitoring events that have been logged according to the process of FIG. 8, according to some examples described herein.

### DETAILED DESCRIPTION

As summarized above, at least some examples disclosed herein are directed to systems and processes for security system remote device access transparency. In some examples, various events associated with access and monitoring of a customer's security system by a monitoring service are logged for the customer to review. Such logs provide customers with transparency into the actions taken by a monitoring service with respect to the customer's data, including images and videos obtained via one or more cameras at a location where the camera or cameras are installed, which is typically at the customer's home or business. The monitoring agent, located remotely from the location of the security system, will have limited access to the customer's cameras or other location-based equipment for purposes including security alarm validation and interacting with persons located at the monitored location via the cameras or other location-based equipment. Actions taken by the monitoring agent on behalf of the customer are recorded to a user-accessible log, which the customer can review via a graphical user interface of a computing device such as a personal computer or smartphone. Providing the customer with the logs helps increase trust with the monitoring service.

In further detail, consumer home security systems provide the ability for owners to monitor Internet-connected cameras installed at their property via a computer or mobile application. For example, using the application, a user can view a live or recorded camera video feed from virtually anywhere there is an Internet connection. In some examples, the camera, the application, or a monitoring service with access to the video feed can automatically process the video to detect events such as motion and the presence of people or objects and send alerts of the events to the user. The user and/or the monitoring agent can review the video to determine whether further action (such as alerting law enforcement or emergency services) is needed, or to archive the video for future reference (such as for review by law enforcement or for use in legal proceedings). In some examples, any video generated by the camera is stored locally (e.g., on a removable, solid state memory card or on a locally maintained server) or, if stored remotely, the data is encrypted such that only the owner of the security system can view the video.

However, some existing home security systems do not permit a monitoring service to securely access or interact with the camera while also providing concurrent notifications of such access and interactions to customers that own the security systems. There are several reasons for such shortcomings. For one, monitoring services may not wish to bear risk or responsibility for determining whether to summon the customer, law enforcement, or emergency services on the basis of a video alone, instead preferring to let the customer or property owner make such decisions. For another, customers have expressed generalized privacy and trust concerns when third parties have access to personal data, including camera views of their homes and other property. Existing solutions do not adequately address customer privacy and data control concerns, including providing transparency into actions taken by the monitoring service with respect to a customer's security system. For instance, in some cases monitoring services have been subject to security breaches that compromised the security of data that the customer did not clearly recognize was being held or used by the monitoring service because of insufficient or unclear notice from the monitoring services.

To this end, examples of the present disclosure permit a monitoring service to remotely access one or more cameras at a customer location while providing transparency of such access to the customer, and to take further actions, such as notifying the customer, law enforcement, emergency services, or another entity. Events associated with monitoring service agent activity are logged and reported to the customer via an event timeline, which provides the user with information regarding the monitoring service agent activities. Such activities include, for example, agent access to the camera, agent viewing the camera, agent interacting with the camera (such as enabling bi-directional audio communications), and agent terminating camera access.

The event timeline also provides the technical ability for the monitoring service to access a customer's camera video and/or audio independently of the customer while simultaneously allowing the customer to remain informed of current actions taken by the monitoring service via events logged to the event timeline. This is particularly useful, for example, while the monitoring service is responding to an alarm by remotely accessing one or more cameras at the customer's location to verify the alarm is not false and to potentially take additional responsive actions, such as notifying law enforcement or emergency services. For example, rather than requiring the customer to participate concurrently with the monitoring service (e.g., by concurrently accessing the cameras with the monitoring service agent, or by requiring the customer to grant permission for the monitoring service to access the cameras each time an alarm occurs), the monitoring service can keep the customer apprised of its progress by logging events to the timeline that inform the customer as to the current status of the alarm response (e.g., when camera access begins and ends, when the monitoring service notifies law enforcement or emergency services, and other actions performed by the monitoring service during an alarm response). This also allows the customer, via a web-based or smartphone application, to keep track of the progress of the monitoring service from any location, including locations away from the monitored location, and to interact with the event timeline to retrieve video and/or audio that has been accessed by the monitoring service. A technical effect of the disclosed techniques, including the event timeline as described herein, is to permit the monitoring service to perform actions including remotely accessing cameras at a customer location, reviewing the videos, and taking additional actions in response to an alarm without requiring the customer to be interactively involved in the process, which increases the transparency of the actions taken by monitoring service to the customer in a manner that is not obtainable with existing solutions.

For instance, the disclosed techniques permit users to receive notifications regarding actions taken by monitoring service agents with respect to the security system. These notifications, which can be logged and presented in a timeline format, increase transparency and visibility into agent actions, including alerting the user when the agent begins and ends camera access, which helps improve the user's trust of the monitoring service with respect to privacy. The event timeline includes messages, alerts, or other information presented via a graphical user interface of an application executing on a computer, smartphone, or other such device. The event timeline includes, for example, descriptions of various events associated with actions taken by the monitoring service agents along with the date and time that each event occurred. The events can be displayed in a chronological format so that they appear sorted in the sequence that they occurred. The user can review the events to better understand what actions were taken by the monitoring service when responding to an alarm (e.g., beginning and ending camera access) and, in some examples, provide links to video and/or audio that was recorded contemporaneously with the actions taken by the monitoring service agent so that the user can see and hear what the monitoring service agent saw and heard while remotely interacting with the cameras.

Whereas various examples are described herein, it will be apparent to those of ordinary skill in the art that many more examples and implementations are possible. Accordingly, the examples described herein are not the only possible examples and implementations. Furthermore, the advantages described above are not necessarily the only advantages, and it is not necessarily expected that all of the described advantages will be achieved with every example.

For the purposes of promoting an understanding of the principles of the present disclosure, reference will now be made to the examples illustrated in the drawings, and specific language will be used to describe the same. It will nevertheless be understood that no limitation of the scope of the examples described herein is thereby intended.

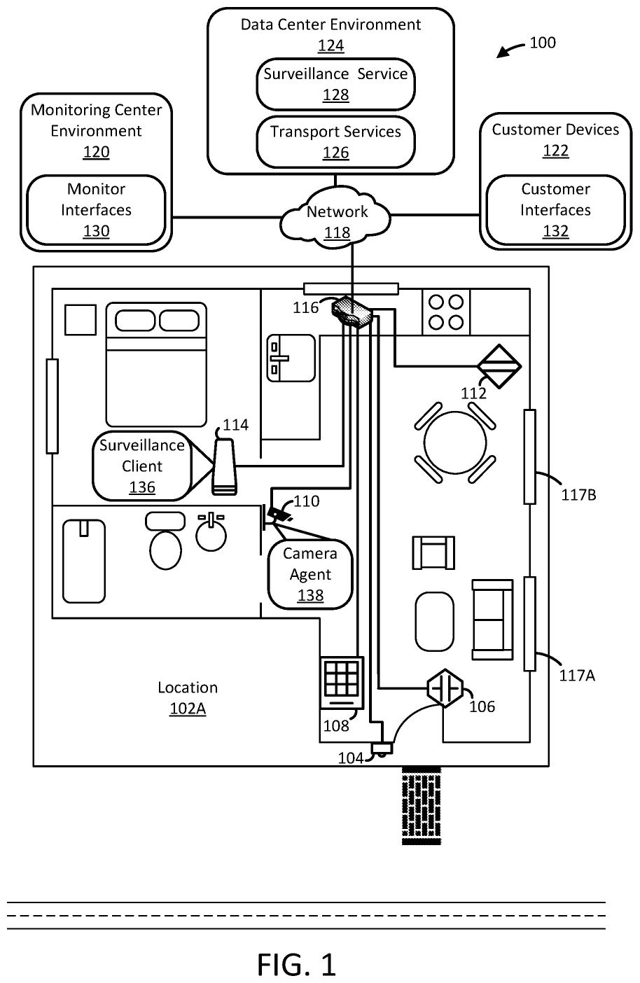

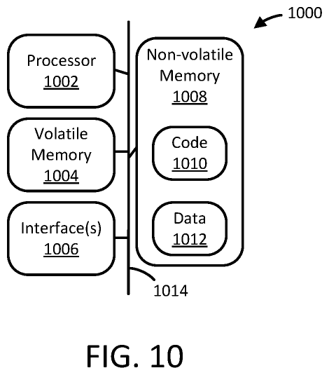

FIG. 1 is a schematic diagram of a security system 100 configured to monitor geographically disparate locations in accordance with some examples. As shown in FIG. 1, the system 100 includes a monitored location 102A, a monitoring center environment 120, a data center environment 124, one or more customer devices 122, and a communication network 118. Each of the monitored location 102A, the monitoring center 120, the data center 124, the one or more customer devices 122, and the communication network 118 include one or more computing devices (e.g., as described below with reference to FIG. 10). The one or more customer devices 122 are configured to host one or more customer interface applications 132. The monitoring center environment 120 is configured to host one or more monitor interface applications 130. The data center environment 124 is configured to host a surveillance service 128 and one or more transport services 126. The location 102A includes image capture devices 104 and 110, a contact sensor assembly 106, a keypad 108, a motion sensor assembly 112, a base station 114, and a router 116. The base station 114 hosts a surveillance client 136. The image capture device 110 hosts a camera agent 138. The security devices disposed at the location 102A (e.g., devices 104, 106, 108, 110, 112, and 114) may be referred to herein as location-based devices.

In some examples, the router 116 is a wireless router that is configured to communicate with the location-based devices via communications that comport with a communications standard such as any of the various Institute of Electrical and Electronics Engineers (IEEE) 108.11 standards. As illustrated in FIG. 1, the router 116 is also configured to communicate with the network 118. It should be noted that the router 116 implements a local area network (LAN) within and proximate to the location 102A by way of example only. Other networking technology that involves other computing devices is suitable for use within the location 102A. For instance, in some examples, the base station 114 can receive and forward communication packets transmitted by the image capture device 110 via a point-to-point personal area network (PAN) protocol, such as BLUETOOTH. Other wired, wireless, and mesh network technology and topologies will be apparent with the benefit of this disclosure and are intended to fall within the scope of the examples disclosed herein.

Continuing with the example of FIG. 1, the network 118 can include one or more public and/or private networks that support, for example, IP. The network 118 may include, for example, one or more LANs, one or more PANs, and/or one or more wide area networks (WANs). The LANs can include wired or wireless networks that support various LAN standards, such as a version of IEEE 108.11 and the like. The PANs can include wired or wireless networks that support various PAN standards, such as BLUETOOTH, ZIGBEE, and the like. The WANs can include wired or wireless networks that support various WAN standards, such as the Code Division Multiple Access (CDMA) radio standard, the Global System for Mobiles (GSM) radio standard, and the like. The network 118 connects and enables data communication between the computing devices within the location 102A, the monitoring center environment 120, the data center environment 124, and the customer devices 122. In at least some examples, both the monitoring center environment 120 and the data center environment 124 include network equipment (e.g., similar to the router 116) that is configured to communicate with the network 118 and computing devices collocated with or near the network equipment. It should be noted that, in some examples, the network 118 and the network extant within the location 102A support other communication protocols, such as MQTT or other IoT protocols.

Continuing with the example of FIG. 1, the data center environment 124 can include physical space, communications, cooling, and power infrastructure to support networked operation of computing devices. For instance, this infrastructure can include rack space into which the computing devices are installed, uninterruptible power supplies, cooling plenum and equipment, and networking devices. The data center environment 124 can be dedicated to the security system 100, can be a non-dedicated, commercially available cloud computing service (e.g., MICROSOFT AZURE, AMAZON WEB SERVICES, GOOGLE CLOUD, or the like), or can include a hybrid configuration made up of dedicated and non-dedicated resources. Regardless of its physical or logical configuration, as shown in FIG. 1, the data center environment 124 is configured to host the surveillance service 128 and the transport services 126.

Continuing with the example of FIG. 1, the monitoring center environment 120 can include a plurality of computing devices (e.g., desktop computers) and network equipment (e.g., one or more routers) connected to the computing devices and the network 118. The customer devices 122 can include personal computing devices (e.g., a desktop computer, laptop, tablet, smartphone, or the like) and network equipment (e.g., a router, cellular modem, cellular radio, or the like). As illustrated in FIG. 1, the monitoring center environment 120 is configured to host the monitor interfaces 130 and the customer devices 122 are configured to host the customer interfaces 132.

Continuing with the example of FIG. 1, the devices 104, 106, 110, and 112 are configured to acquire analog signals via sensors incorporated into the devices, generate digital sensor data based on the acquired signals, and communicate (e.g. via a wireless link with the router 116) the sensor data to the base station 114. The type of sensor data generated and communicated by these devices varies along with the type of sensors included in the devices. For instance, the image capture devices 104 and 110 can acquire ambient light, generate frames of image data based on the acquired light, and communicate the frames to the base station 114, the monitor interfaces 130, and/or the customer interfaces 132, although the pixel resolution and frame rate may vary depending on the capabilities of the devices. As shown in FIG. 1, the image capture device 104 has a field of view (FOV) that originates proximal to a front door of the location 102A and can acquire images of a walkway, highway, and a space between the location 102A and the highway. The image capture device 110 has an FOV that originates proximal to a bathroom of the location 102A and can acquire images of a living room and dining area of the location 102A. The image capture device 110 can further acquire images of outdoor areas beyond the location 102A through windows 117A and 117B on the right side of the location 102A.

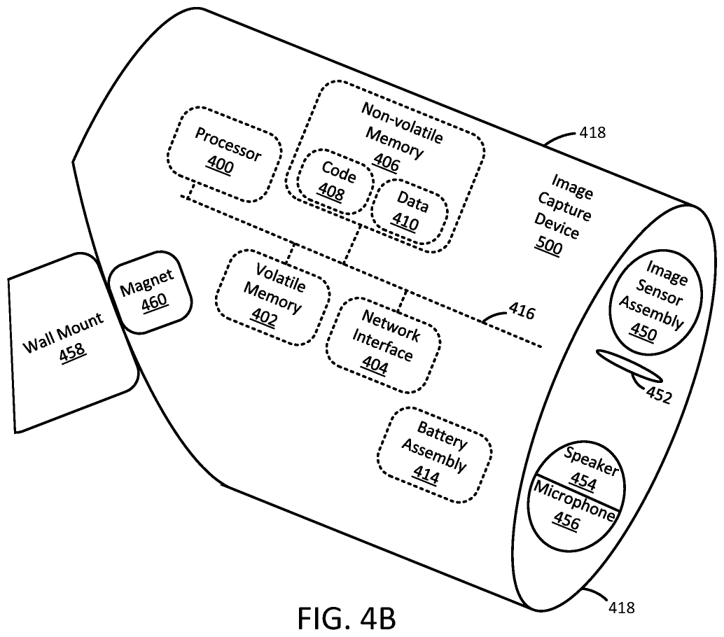

Further, as shown in FIG. 1, in some examples the image capture device 110 is configured to communicate with the surveillance service 128, the monitor interfaces 130, and the customer interfaces 132 separately from the surveillance client 136 via execution of the camera agent 138. These communications can include sensor data generated by the image capture device 110 and/or commands to be executed by the image capture device 110 sent by the surveillance service 128, the monitor interfaces 130, and/or the customer interfaces 132. The commands can include, for example, requests for interactive communication sessions in which monitoring personnel and/or customers interact with the image capture device 110 via the monitor interfaces 130 and the customer interfaces 132. These interactions can include requests for the image capture device 110 to transmit additional sensor data, requests for the image capture device 110 to render output via a user interface (e.g., the user interface 412 of FIG. 4B), and/or to interact with a speaker and microphone of the image capture device 110. This output can include audio and/or video output.

Continuing with the example of FIG. 1, the contact sensor assembly 106 includes a sensor that can detect the presence or absence of a magnetic field generated by a magnet when the magnet is proximal to the sensor. When the magnetic field is present, the contact sensor assembly 106 generates Boolean sensor data specifying a closed state. When the magnetic field is absent, the contact sensor assembly 106 generates Boolean sensor data specifying an open state. In either case, the contact sensor assembly 106 can communicate sensor data indicating whether the front door of the location 102A is open or closed to the base station 114. The motion sensor assembly 112 can include an audio emission device that can radiate sound (e.g., ultrasonic) waves and an audio sensor that can acquire reflections of the waves. When the audio sensor detects the reflection because no objects are in motion within the space monitored by the audio sensor, the motion sensor assembly 112 generates Boolean sensor data specifying a still state. When the audio sensor does not detect a reflection because an object is in motion within the monitored space, the motion sensor assembly 112 generates Boolean sensor data specifying an alert state. In either case, the motion sensor assembly 112 can communicate the sensor data to the base station 114. It should be noted that the specific sensing modalities described above are not limiting to the present disclosure. For instance, as one of many potential examples, the motion sensor assembly 112 can base its operation on acquisition of changes in temperature rather than changes in reflected sound waves.

Continuing with the example of FIG. 1, the keypad 108 is configured to interact with a user and interoperate with the other location-based devices in response to interactions with the user. For instance, in some examples, the keypad 108 is configured to receive input from a user that specifies one or more commands and to communicate the specified commands to one or more addressed processes. These addressed processes can include processes implemented by one or more of the location-based devices and/or one or more of the monitor interfaces 130 or the surveillance service 128. The commands can include, for example, codes that authenticate the user as a resident of the location 102A and/or codes that request activation or deactivation of one or more of the location-based devices. Alternatively or additionally, in some examples, the keypad 108 includes a user interface (e.g., a tactile interface, such as a set of physical buttons or a set of virtual buttons on a touchscreen) configured to interact with a user (e.g., receive input from and/or render output to the user). Further still, in some examples, the keypad 108 can receive and respond to the communicated commands and render the responses via the user interface as visual or audio output.

Continuing with the example of FIG. 1, the base station 114 is configured to interoperate with the other location-based devices to provide local command and control and store-and-forward functionality via execution of the surveillance client 136. In some examples, to implement store-and-forward functionality, the base station 114, through execution of the surveillance client 136, receives sensor data, packages the data for transport, and stores the packaged sensor data in local memory for subsequent communication. This communication of the packaged sensor data can include, for instance, transmission of the packaged sensor data as a payload of a message to one or more of the transport services 126 when a communication link to the transport services 126 via the network 118 is operational. In some examples, packaging the sensor data can include filtering the sensor data and/or generating one or more summaries (maximum values, minimum values, average values, changes in values since the previous communication of the same, etc.) of multiple sensor readings. To implement local command and control functionality, the base station 114 executes, under control of the surveillance client 136, a variety of programmatic operations in response to various events. Examples of these events can include reception of commands from the keypad 108 or the customer interface application 132, reception of commands from one of the monitor interfaces 130 or the customer interface application 132 via the network 118, or detection of the occurrence of a scheduled event. The programmatic operations executed by the base station 114 under control of the surveillance client 136 can include activation or deactivation of one or more of the devices 104, 106, 108, 110, and 112; sounding of an alarm; reporting an event to the surveillance service 128; and communicating location data to one or more of the transport services 126 to name a few operations. The location data can include data specifying sensor readings (sensor data), configuration data of any of the location-based devices, commands input and received from a user (e.g., via the keypad 108 or a customer interface 132), or data derived from one or more of these data types (e.g., filtered sensor data, summarizations of sensor data, event data specifying an event detected at the location via the sensor data, etc.).

Continuing with the example of FIG. 1, the transport services 126 are configured to securely, reliably, and efficiently exchange messages between processes implemented by the location-based devices and processes implemented by other devices in the system 100. These other devices can include the customer devices 122, devices disposed in the data center environment 124, and/or devices disposed in the monitoring center environment 120. In some examples, the transport services 126 are also configured to parse messages from the location-based devices to extract payloads included therein and store the payloads and/or data derived from the payloads within one or more data stores hosted in the data center environment 124. The data housed in these data stores may be subsequently accessed by, for example, the surveillance service 128, the monitor interfaces 130, and the customer interfaces 132.

In certain examples, the transport services 126 expose and implement one or more application programming interfaces (APIs) that are configured to receive, process, and respond to calls from processes (e.g., the surveillance client 136) implemented by base stations (e.g., the base station 114) and/or processes (e.g., the camera agent 138) implemented by other devices (e.g., the image capture device 110). Individual instances of a transport service within the transport services 126 can be associated with and specific to certain manufactures and models of location-based monitoring equipment (e.g., SIMPLISAFE equipment, RING equipment, etc.). The APIs can be implemented using a variety of architectural styles and interoperability standards. For instance, in one example, the API is a web services interface implemented using a representational state transfer (REST) architectural style. In this example, API calls are encoded in Hypertext Transfer Protocol (HTTP) along with JavaScript Object Notation (JSON) and/or extensible markup language (XML). These API calls are addressed to one or more uniform resource locators (URLs) that are API endpoints monitored by the transport services 126. In some examples, portions of the HTTP communications are encrypted to increase security. Alternatively or additionally, in some examples, the API is implemented as an MQTT broker that receives messages and transmits responsive messages to MQTT clients hosted by the base stations and/or the other devices. Alternatively or additionally, in some examples, the API is implemented using simple file transfer protocol commands. Thus, the transport services 126 are not limited to a particular protocol or architectural style. It should be noted that, in at least some examples, the transport services 126 can transmit one or more API calls to location-based devices to request data from, or an interactive communication session with, the location-based devices.

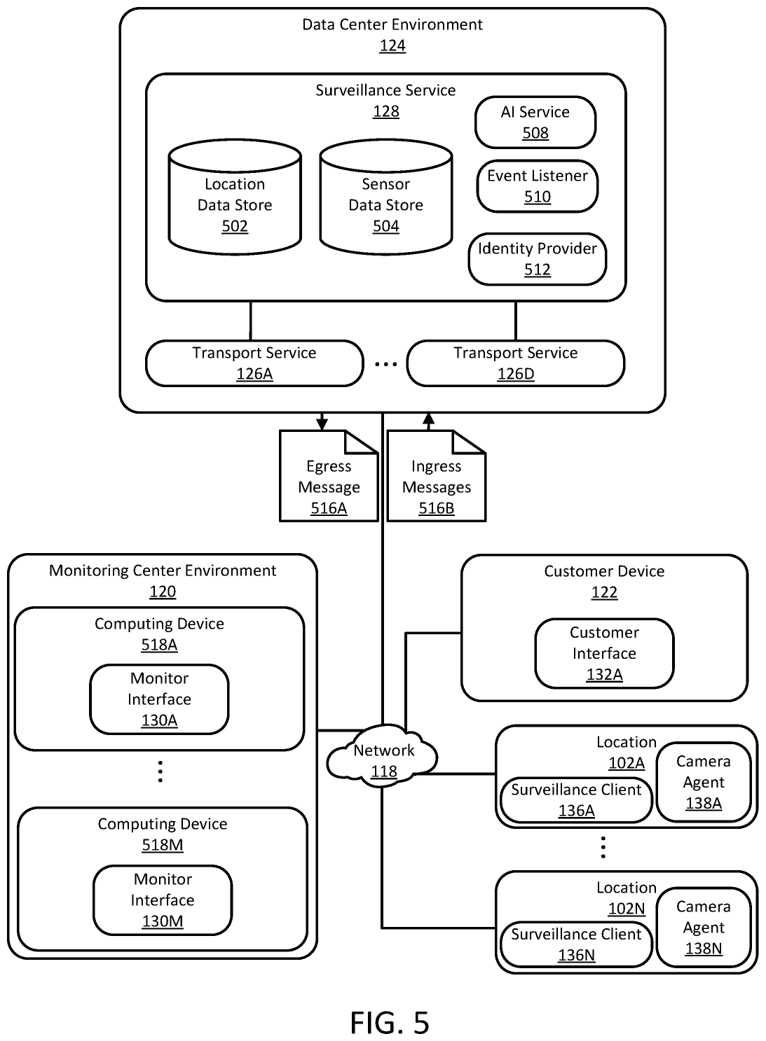

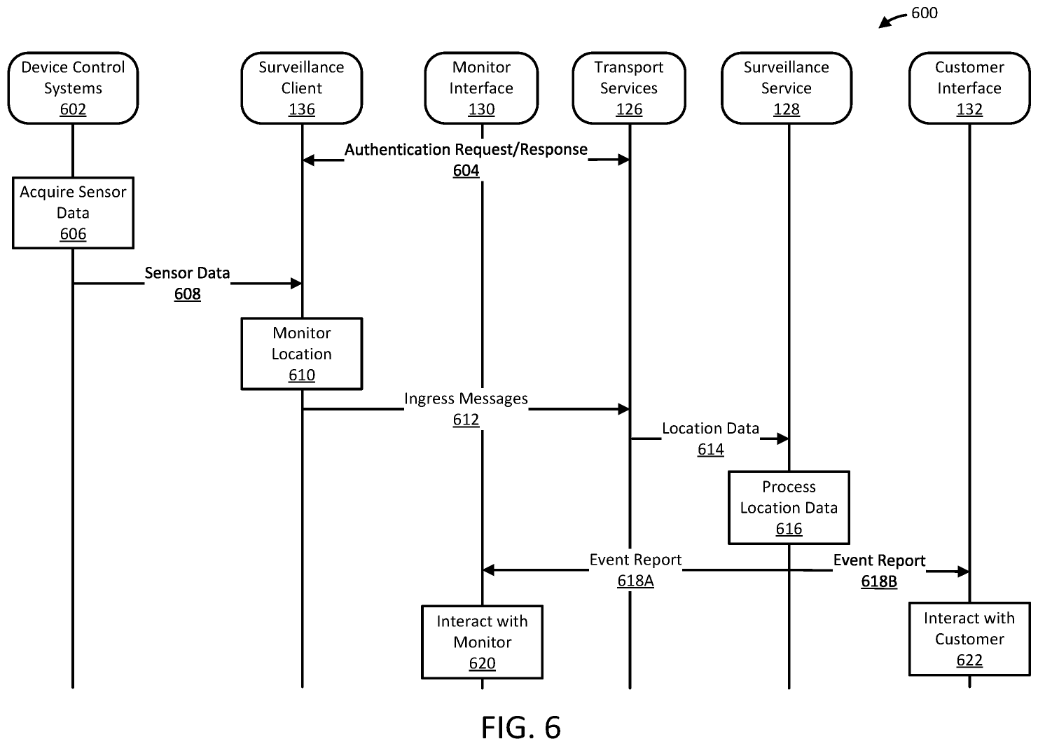

Continuing with the example of FIG. 1, the surveillance service 128 is configured to control overall logical setup and operation of the system 100. As such, the surveillance service 128 can interoperate with the transport services 126, the monitor interfaces 130, the customer interfaces 132, and any of the location-based devices. In some examples, the surveillance service 128 is configured to monitor data from a variety of sources for reportable events (e.g., a break-in event, a monitoring agent event, a begin camera access event, an end camera access event, or other information regarding operation of the system 100) and, when a reportable event is detected, notify one or more of the monitor interfaces 130 and/or the customer interfaces 132 of the reportable event. In some examples, the surveillance service 128 is also configured to maintain state information regarding the location 102A. This state information can indicate, for instance, whether the location 102A is safe or under threat. In certain examples, the surveillance service 128 is configured to change the state information to indicate that the location 102A is safe only upon receipt of a communication indicating a clear event (e.g., rather than making such a change in response to discontinuation of reception of break-in events). This feature can prevent a “crash and smash” robbery from being successfully executed. Further example processes that the surveillance service 128 is configured to execute are described below with reference to FIGS. 5 and 6.

Continuing with the example of FIG. 1, individual monitor interfaces 130 are configured to control computing device interaction with monitoring personnel and to execute a variety of programmatic operations in response to the interactions. For instance, in some examples, the monitor interface 130 controls its host device to provide information regarding reportable events detected at monitored locations, such as the location 102A, to monitoring personnel. Such events can include, for example, movement or an alert condition generated by one or more of the location-based devices. Alternatively or additionally, in some examples, the monitor interface 130 controls its host device to interact with a user to configure features of the system 100. Further example processes that the monitor interface 130 is configured to execute are described below with reference to FIG. 6.

Continuing with the example of FIG. 1, individual customer interfaces 132 are configured to control computing device interaction with a customer and to execute a variety of programmatic operations in response to the interactions. For instance, in some examples, the customer interface 132 controls its host device to provide information regarding reportable events detected at monitored locations, such as the location 102A, to the customer. Such events can include, for example, an alert condition generated by one or more of the location-based devices. Alternatively or additionally, in some examples, the customer interface 132 is configured to process input received from the customer to activate or deactivate one or more of the location-based devices. Further still, in some examples, the customer interface 132 configures features of the system 100 in response to input from a user. Further example processes that the customer interface 132 is configured to execute are described below with reference to FIG. 6.

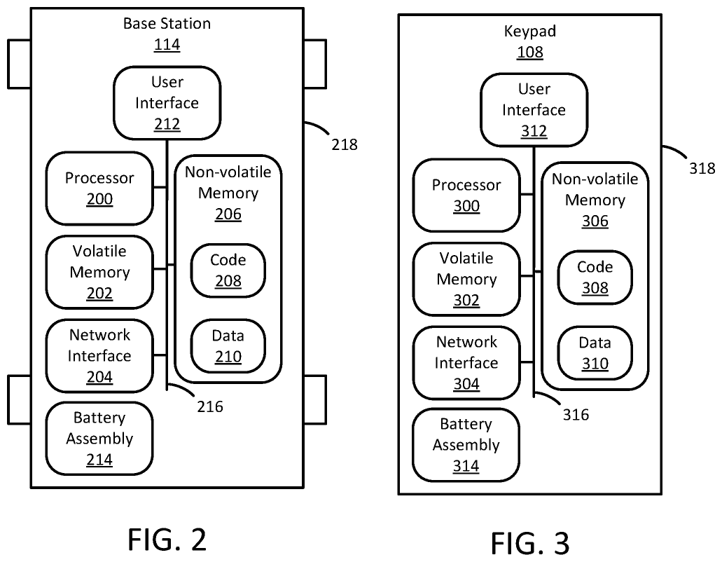

Turning now to FIG. 2, an example base station 114 is schematically illustrated. As shown in FIG. 2, the base station 114 includes at least one processor 200, volatile memory 202, non-volatile memory 206, at least one network interface 204, a user interface 212, a battery assembly 214, and an interconnection mechanism 216. The non-volatile memory 206 stores executable code 208 and includes a data store 210. In some examples illustrated by FIG. 2, the features of the base station 114 enumerated above are incorporated within, or are a part of, a housing 218.

In some examples, the non-volatile (non-transitory) memory 206 includes one or more read-only memory (ROM) chips; one or more hard disk drives or other magnetic or optical storage media; one or more solid state drives (SSDs), such as a flash drive or other solid-state storage media; and/or one or more hybrid magnetic and SSDs. In certain examples, the code 208 stored in the non-volatile memory can include an operating system and one or more applications or programs that are configured to execute under the operating system. Alternatively or additionally, the code 208 can include specialized firmware and embedded software that is executable without dependence upon a commercially available operating system. Regardless, execution of the code 208 can implement the surveillance client 136 of FIG. 1 and can result in manipulated data that is a part of the data store 210.

Continuing the example of FIG. 2, the processor 200 can include one or more programmable processors to execute one or more executable instructions, such as a computer program specified by the code 208, to control the operations of the base station 114. As used herein, the term “processor” describes circuitry that executes a function, an operation, or a sequence of operations. The function, operation, or sequence of operations can be hard coded into the circuitry or soft coded by way of instructions held in a memory device (e.g., the volatile memory 202) and executed by the circuitry. In some examples, the processor 200 is a digital processor, but the processor 200 can be analog, digital, or mixed. As such, the processor 200 can execute the function, operation, or sequence of operations using digital values and/or using analog signals. In some examples, the processor 200 can be embodied in one or more application specific integrated circuits (ASICs), microprocessors, digital signal processors (DSPs), graphics processing units (GPUs), neural processing units (NPUs), microcontrollers, field programmable gate arrays (FPGAs), programmable logic arrays (PLAs), or multicore processors. Examples of the processor 200 that are multicore can provide functionality for parallel, simultaneous execution of instructions or for parallel, simultaneous execution of one instruction on more than one piece of data.

Continuing with the example of FIG. 2, prior to execution of the code 208 the processor 200 can copy the code 208 from the non-volatile memory 206 to the volatile memory 202. In some examples, the volatile memory 202 includes one or more static or dynamic random-access memory (RAM) chips and/or cache memory (e.g. memory disposed on a silicon die of the processor 200). Volatile memory 202 can offer a faster response time than a main memory, such as the non-volatile memory 206.

Through execution of the code 208, the processor 200 can control operation of the network interface 204. For instance, in some examples, the network interface 204 includes one or more physical interfaces (e.g., a radio, an ethernet port, a universal serial bus (USB) port, etc.) and a software stack including drivers and/or other code 208 that is configured to communicate with the one or more physical interfaces to support one or more LAN, PAN, and/or WAN standard communication protocols. The communication protocols can include, for example, transmission control protocol (TCP), user datagram protocol (UDP), HTTP, and MQTT among others. As such, the network interface 204 enables the base station 114 to access and communicate with other computing devices (e.g., the location-based devices) via a computer network (e.g., the LAN established by the router 116 of FIG. 1, the network 118 of FIG. 1, and/or a point-to-point connection). For instance, in at least one example, the network interface 204 utilizes sub-GHz wireless networking to transmit wake messages to the other computing devices to request streams of sensor data or other operations. Use of sub-GHz wireless networking can improve operable communication distances and/or reduce power consumed to communicate.

Through execution of the code 208, the processor 200 can control operation of the user interface 212. For instance, in some examples, the user interface 212 includes user input and/or output devices (e.g., a keyboard, a mouse, a touchscreen, a display, a speaker, a camera, an accelerometer, a biometric scanner, an environmental sensor, etc.) and a software stack including drivers and/or other code 208 that is configured to communicate with the user input and/or output devices. For instance, the user interface 212 can be implemented by a customer device 122 hosting a mobile application (e.g., a customer interface 132). The user interface 212 enables the base station 114 to interact with users to receive input and/or render output. This rendered output can include, for instance, one or more graphical user interfaces (GUIs) including one or more controls configured to display output and/or receive input. The input can specify values to be stored in the data store 210. The output can indicate values stored in the data store 210. It should be noted that, in some examples, parts of the user interface 212 are accessible and/or visible as part of, or through, the housing 218. These parts of the user interface 212 can include, for example, one or more light-emitting diodes (LEDs). Alternatively or additionally, in some examples, the user interface 212 includes a 95 db siren that the processor 200 sounds to indicate that a break-in event has been detected.

Continuing with the example of FIG. 2, the various features of the base station 114 described above can communicate with one another via the interconnection mechanism 216. In some examples, the interconnection mechanism 216 includes a communications bus. In addition, in some examples, the battery assembly 214 is configured to supply operational power to the various features of the base station 114 described above. In some examples, the battery assembly 214 includes at least one rechargeable battery (e.g., one or more NiMH or lithium batteries). In some examples, the rechargeable battery has a runtime capacity sufficient to operate the base station 114 for 24 hours or longer while the base station 114 is disconnected from or otherwise not receiving line power. Alternatively or additionally, in some examples, the battery assembly 214 includes power supply circuitry to receive, condition, and distribute line power to both operate the base station 114 and recharge the rechargeable battery. The power supply circuitry can include, for example, a transformer and a rectifier, among other circuitry, to convert AC line power to DC device and recharging power.

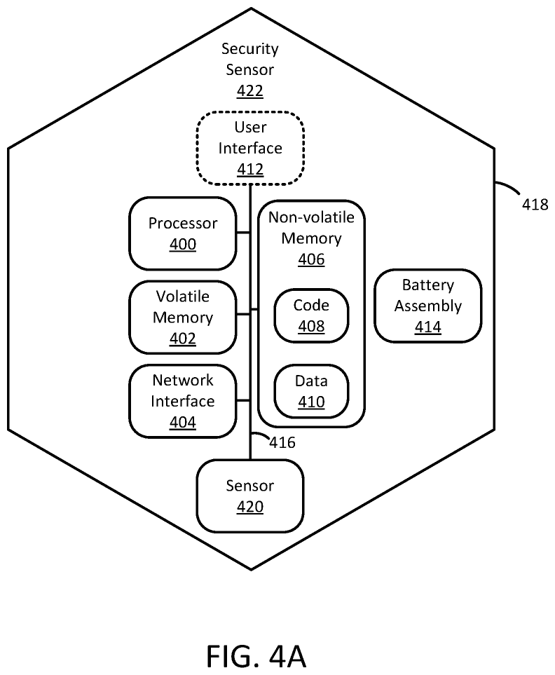

Turning now to FIG. 3, an example keypad 108 is schematically illustrated. As shown in FIG. 3, the keypad 108 includes at least one processor 300, volatile memory 302, non-volatile memory 306, at least one network interface 304, a user interface 312, a battery assembly 314, and an interconnection mechanism 316. The non-volatile memory 306 stores executable code 308 and a data store 310. In some examples illustrated by FIG. 3, the features of the keypad 108 enumerated above are incorporated within, or are a part of, a housing 318.

In some examples, the respective descriptions of the processor 200, the volatile memory 202, the non-volatile memory 206, the interconnection mechanism 216, and the battery assembly 214 with reference to the base station 114 are applicable to the processor 300, the volatile memory 302, the non-volatile memory 306, the interconnection mechanism 316, and the battery assembly 314 with reference to the keypad 108. As such, those descriptions will not be repeated.

Continuing with the example of FIG. 3, through execution of the code 308, the processor 300 can control operation of the network interface 304. In some examples, the network interface 304 includes one or more physical interfaces (e.g., a radio, an ethernet port, a USB port, etc.) and a software stack including drivers and/or other code 308 that is configured to communicate with the one or more physical interfaces to support one or more LAN, PAN, and/or WAN standard communication protocols. These communication protocols can include, for example, TCP, UDP, HTTP, and MQTT among others. As such, the network interface 304 enables the keypad 108 to access and communicate with other computing devices (e.g., the other location-based devices) via a computer network (e.g., the LAN established by the router 116 and/or a point-to-point connection).

Continuing with the example of FIG. 3, through execution of the code 308, the processor 300 can control operation of the user interface 312. In some examples, the user interface 312 includes user input and/or output devices (e.g., physical keys arranged as a keypad, a touchscreen, a display, a speaker, a camera, a biometric scanner, an environmental sensor, etc.) and a software stack including drivers and/or other code 308 that is configured to communicate with the user input and/or output devices. As such, the user interface 312 enables the keypad 108 to interact with users to receive input and/or render output. This rendered output can include, for instance, one or more GUIs including one or more controls configured to display output and/or receive input. The input can specify values to be stored in the data store 310. The output can indicate values stored in the data store 310. It should be noted that, in some examples, parts of the user interface 312 (e.g., one or more LEDs) are accessible and/or visible as part of, or through, the housing 318.

Turning now to FIG. 4A, an example security sensor 422 is schematically illustrated. Particular configurations of the security sensor 422 (e.g., the image capture devices 104 and 110, the motion sensor assembly 112, and the contact sensor assemblies 106) are illustrated in FIG. 1 and described above. As shown in FIG. 4A, the security sensor 422 includes at least one processor 400, volatile memory 402, non-volatile memory 406, at least one network interface 404, a battery assembly 414, an interconnection mechanism 416, and at least one sensor assembly 420. The non-volatile memory 406 stores executable code 408 and a data store 410. Some examples include a user interface 412. In certain examples illustrated by FIG. 4A, the features of the security sensor 422 enumerated above are incorporated within, or are a part of, a housing 418.

In some examples, the respective descriptions of the processor 200, the volatile memory 202, the non-volatile memory 206, the interconnection mechanism 216, and the battery assembly 214 with reference to the base station 114 are applicable to the processor 400, the volatile memory 402, the non-volatile memory 406, the interconnection mechanism 416, and the battery assembly 414 with reference to the security sensor 422. As such, those descriptions will not be repeated.

Continuing with the example of FIG. 4A, through execution of the code 408, the processor 400 can control operation of the network interface 404. In some examples, the network interface 404 includes one or more physical interfaces (e.g., a radio (including an antenna), an ethernet port, a USB port, etc.) and a software stack including drivers and/or other code 408 that is configured to communicate with the one or more physical interfaces to support one or more LAN, PAN, and/or WAN standard communication protocols. The communication protocols can include, for example, TCP, UDP, HTTP, and MQTT among others. As such, the network interface 404 enables the security sensor 422 to access and communicate with other computing devices (e.g., the other location-based devices) via a computer network (e.g., the LAN established by the router 116 and/or a point-to-point connection). For instance, in at least one example, when executing the code 408, the processor 400 controls the network interface to stream (e.g., via UDP) sensor data acquired from the sensor assembly 420 to the base station 114. Alternatively or additionally, in at least one example, through execution of the code 408, the processor 400 can control the network interface 404 to enter a power conservation mode by powering down a 2.4 GHz radio and powering up a sub-GHz radio that are both included in the network interface 404. In this example, through execution of the code 408, the processor 400 can control the network interface 404 to enter a streaming or interactive mode by powering up a 2.4 GHz radio and powering down a sub-GHz radio, for example, in response to receiving a wake signal from the base station via the sub-GHz radio.

Continuing with the example of FIG. 4A, through execution of the code 408, the processor 400 can control operation of the user interface 412. In some examples, the user interface 412 includes user input and/or output devices (e.g., physical buttons, a touchscreen, a display, a speaker, a camera, an accelerometer, a biometric scanner, an environmental sensor, one or more LEDs, etc.) and a software stack including drivers and/or other code 408 that is configured to communicate with the user input and/or output devices. As such, the user interface 412 enables the security sensor 422 to interact with users to receive input and/or render output. This rendered output can include, for instance, one or more GUIs including one or more controls configured to display output and/or receive input. The input can specify values to be stored in the data store 410. The output can indicate values stored in the data store 410. It should be noted that, in some examples, parts of the user interface 412 are accessible and/or visible as part of, or through, the housing 418.

Continuing with the example of FIG. 4A, the sensor assembly 420 can include one or more types of sensors, such as the sensors described above with reference to the image capture devices 104 and 110, the motion sensor assembly 112, and the contact sensor assembly 106 of FIG. 1, or other types of sensors. For instance, in at least one example, the sensor assembly 420 includes an image sensor (e.g., a charge-coupled device or an active-pixel sensor) and a temperature sensor. Regardless of the type of sensor or sensors housed, the processor 400 can (e.g., via execution of the code 408) acquire sensor data from the housed sensor and stream the acquired sensor data to the processor 400 for communication to the base station.

It should be noted that, in some examples of the devices 108 and 422, the operations executed by the processors 300 and 400 while under control of respective control of the code 308 and 408 may be hardcoded and/or implemented in hardware, rather than as a combination of hardware and software. Moreover, execution of the code 408 can implement the camera agent 138 of FIG. 1 and can result in manipulated data that is a part of the data store 410.

Turning now to FIG. 4B, an example image capture device 500 is schematically illustrated. Particular configurations of the image capture device 500 (e.g., the image capture devices 104 and 110) are illustrated in FIG. 1 and described above. As shown in FIG. 4B, the image capture device 500 includes at least one processor 400, volatile memory 402, non-volatile memory 406, at least one network interface 404, a battery assembly 414, and an interconnection mechanism 416. These features of the image capture device are illustrated in dashed lines to indicate that they reside within a housing 418. The non-volatile memory 406 stores executable code 408 and a data store 410.

Some examples further include an image sensor assembly 450, a light 452, a speaker 454, a microphone 456, a wall mount 458, and a magnet 460. The image sensor assembly 450 may include a lens and an image sensor. The light 452 may include a light emitting diode (LED), such as a red-green-blue emitting LED. The light 452 may also include an infrared emitting diode in some examples. The speaker 454 may include a transducer configured to emit sound in the range of 60 dB to 80 dB or louder. Further, in some examples, the speaker 454 can include a siren configured to emit sound in the range of 70 dB to 90 db or louder. The microphone 456 may include a micro electro-mechanical system (MEMS) microphone. The wall mount 458 may include a mounting bracket, configured to accept screws or other fasteners that adhere the bracket to a wall, and a cover configured to mechanically couple to the mounting bracket. In some examples, the cover is composed of a magnetic material, such as aluminum or stainless steel, to enable the magnet 460 to magnetically couple to the wall mount 458, thereby holding the image capture device 500 in place.

In some examples, the respective descriptions of the processor 400, the volatile memory 402, the network interface 404, the non-volatile memory 406, the code 408 with respect to the network interface 404, the interconnection mechanism 416, and the battery assembly 414 with reference to the security sensor 422 are applicable to these same features with reference to the image capture device 500. As such, those descriptions will not be repeated here.

Continuing with the example of FIG. 4B, through execution of the code 408, the processor 400 can control operation of the image sensor assembly 450, the light 452, the speaker 454, and the microphone 456. For instance, in at least one example, when executing the code 408, the processor 400 controls the image sensor assembly 450 to acquire sensor data, in the form of image data, to be stream to the base station 114 (or one of the processes 130, 128, or 132 of FIG. 1) via the network interface 404. Alternatively or additionally, in at least one example, through execution of the code 408, the processor 400 controls the light 452 to emit light so that the image sensor assembly 450 collects sufficient reflected light to compose the image data. Further, in some examples, through execution of the code 408, the processor 400 controls the speaker 454 to emit sound. This sound may be locally generated (e.g., a sonic alert via the siren) or streamed from the base station 114 (or one of the processes 130, 128 or 132 of FIG. 1) via the network interface 404 (e.g., utterances from the user or monitoring personnel). Further still, in some examples, through execution of the code 408, the processor 400 controls the microphone 456 to acquire sensor data in the form of sound for streaming to the base station 114 (or one of the processes 130, 128 or 132 of FIG. 1) via the network interface 404.

It should be appreciated that in the example of FIG. 4B, the light 452, the speaker 454, and the microphone 456 implement an instance of the user interface 412 of FIG. 4A. It should also be appreciated that the image sensor assembly 450 and the light 452 implement an instance of the sensor assembly 420 of FIG. 4A.

Turning now to FIG. 5, aspects of the data center environment 124 of FIG. 1, the monitoring center environment 120 of FIG. 1, one of the customer devices 122 of FIG. 1, the network 118 of FIG. 1, and a plurality of monitored locations 102A of FIG. 1 through 102N (collectively referred to as the locations 102) are schematically illustrated. As shown in FIG. 5, the data center environment 124 hosts the surveillance service 128 and the transport services 126 (individually referred to as the transport services 126A through 126D). The surveillance service 128 includes a location data store 502, a sensor data store 504, an artificial intelligence (AI) service 508, an event listening service 510, and an identity provider 512. The monitoring center environment 120 includes computing devices 518A through 518M (collectively referred to as the computing devices 518) that host monitor interfaces 130A through 130M. Individual locations 102A through 102N include base stations (e.g., the base station 114 of FIG. 1, not shown) that host the surveillance clients 136A through 136N (collectively referred to as the surveillance clients 136) and image capture devices (e.g., the image capture device 110 of FIG. 1, not shown) that host the software camera agents 138A through 138N (collectively referred to as the camera agents 138).

As shown in FIG. 5, the transport services 126 are configured to process ingress messages 516B from the customer interface 132A, the surveillance clients 136, the camera agents 138, and/or the monitor interfaces 130. The transport services 126 are also configured to process egress messages 516A addressed to the customer interface 132A, the surveillance clients 136, the camera agents 138, and the monitor interfaces 130. The location data store 502 is configured to store, within a plurality of records, location data in association with identifiers of customers for whom the location is monitored. For example, the location data may be stored in a record with an identifier of a customer and/or an identifier of the location to associate the location data with the customer and the location. The sensor data store 504 is configured to store, within a plurality of records, sensor data (e.g., one or more frames of image data) in association with identifiers of locations and timestamps at which the sensor data was acquired.

Continuing with the example of FIG. 5, the AI service 508 is configured to process sensor data (e.g., images and/or sequences of images) to identify movement, human faces, and other features within the sensor data. The event listening service 510 is configured to scan location data transported via the ingress messages 516B for events and, where an event is identified, execute one or more event handlers to process the event. In some examples, the event handlers can include an event reporter that is configured to identify reportable events and to communicate messages specifying the reportable events to one or more recipient processes (e.g., a customer interface 132 and/or a monitor interface 130). In some examples, the event listening service 510 can interoperate with the AI service 508 to identify events within sensor data. The identity provider 512 is configured to receive, via the transport services 126, authentication requests from the surveillance clients 136 or the camera agents 138 that include security credentials. When the identity provider 512 can authenticate the security credentials in a request (e.g., via a validation function, cross-reference look-up, or some other authentication process), the identity provider 512 can communicate a security token in response to the request. A surveillance client 136 or a camera agent 138 can receive, store, and include the security token in subsequent ingress messages 516B, so that the transport service 126A is able to securely process (e.g., unpack/parse) the packages included in the ingress messages 516B to extract the location data prior to passing the location data to the surveillance service 128.

Continuing with the example of FIG. 5, the transport services 126 are configured to receive the ingress messages 516B, verify the authenticity of the messages 516B, parse the messages 516B, and extract the location data encoded therein prior to passing the location data to the surveillance service 128 for processing. This location data can include any of the location data described above with reference to FIG. 1. Individual transport services 126 may be configured to process ingress messages 516B generated by location-based monitoring equipment of a particular manufacturer and/or model. The surveillance clients 136 and the camera agents 138 are configured to generate and communicate, to the surveillance service 128 via the network 118, ingress messages 516B that include packages of location data based on sensor information received at the locations 102.

Continuing with the example of FIG. 5, the computing devices 518 are configured to host the monitor interfaces 130. In some examples, individual monitor interfaces 130A-130M are configured to render GUIs including one or more image frames and/or other sensor data. In certain examples, the customer device 122 is configured to host the customer interface 132. In some examples, customer interface 132 is configured to render GUIs including one or more image frames and/or other sensor data. Additional features of the monitor interfaces 130 and the customer interface 132 are described further below with reference to FIG. 6.

Turning now to FIG. 6, a monitoring process 600 is illustrated as a sequence diagram. The process 600 can be executed, in some examples, by a security system (e.g., the security system 100 of FIG. 1). More specifically, in some examples, at least a portion of the process 600 is executed by the location-based devices under the control of device control system (DCS) code (e.g., either the code 308 or 408) implemented by at least one processor (e.g., either of the processors 300 or 400 of FIG. 3 or 4). The DCS code can include, for example, a camera agent (e.g., the camera agent 138 of FIG. 1). At least a portion of the process 600 is executed by a base station (e.g., the base station 114 of FIG. 1) under control of a surveillance client (e.g., the surveillance client 136 of FIG. 1). At least a portion of the process 600 is executed by a monitoring center environment (e.g., the monitoring center environment 120 of FIG. 1) under control of a monitor interface (e.g., the monitor interface 130 of FIG. 1). At least a portion of the process 600 is executed by a data center environment (e.g., the data center environment 124 of FIG. 1) under control of a surveillance service (e.g., the surveillance service 128 of FIG. 1) or under control of transport services (e.g., the transport services 126 of FIG. 1). At least a portion of the process 600 is executed by a customer device (e.g., the customer device 122 of FIG. 1) under control of a customer interface (e.g., customer interface 132 of FIG. 1).

As shown in FIG. 6, the process 600 starts with the surveillance client 136 authenticating with an identity provider (e.g., the identity provider 512 of FIG. 5) by exchanging one or more authentication requests and responses 604 with the transport service 126. More specifically, in some examples, the surveillance client 136 communicates an authentication request to the transport service 126 via one or more API calls to the transport service 126. In these examples, the transport service 126 parses the authentication request to extract security credentials therefrom and passes the security credentials to the identity provider for authentication. In some examples, if the identity provider authenticates the security credentials, the transport service 126 receives a security token from the identity provider and communicates the security token as a payload within an authentication response to the authentication request. In these examples, if the identity provider is unable to authenticate the security credentials, the transport service 126 generates an error code and communicates the error code as the payload within the authentication response to the authentication request. Upon receipt of the authentication response, the surveillance client 136 parses the authentication response to extract the payload. If the payload includes the error code, the surveillance client 136 can retry authentication and/or interoperate with a user interface of its host device (e.g., the user interface 212 of the base station 114 of FIG. 2) to render output indicating the authentication failure. If the payload includes the security token, the surveillance client 136 stores the security token for subsequent use in communication of location data via ingress messages. It should be noted that the security token can have a limited lifespan (e.g., 1 hour, 1 day, 1 week, 1 month, etc.) after which the surveillance client 136 may be required to reauthenticate with the transport services 126.

Continuing with the process 600, one or more DCSs 602 hosted by one or more location-based devices acquire 606 sensor data descriptive of a location (e.g., the location 102A of FIG. 1). The sensor data acquired can be any of a variety of types, as discussed above with reference to FIGS. 1-4. In some examples, one or more of the DCSs 602 acquire sensor data continuously. In some examples, one or more of the DCSs 602 acquire sensor data in response to an event, such as expiration of a local timer (a push event) or receipt of an acquisition polling signal communicated by the surveillance client 136 (a poll event). In certain examples, one or more of the DCSs 602 stream sensor data to the surveillance client 136 with minimal processing beyond acquisition and digitization. In these examples, the sensor data may constitute a sequence of vectors with individual vector members including a sensor reading and a timestamp. Alternatively or additionally, in some examples, one or more of the DCSs 602 execute additional processing of sensor data, such as generation of one or more summaries of multiple sensor readings. Further still, in some examples, one or more of the DCSs 602 execute sophisticated processing of sensor data. For instance, if the security sensor includes an image capture device, the security sensor may execute image processing routines such as edge detection, motion detection, facial recognition, threat assessment, and reportable event generation.

Continuing with the process 600, the DCSs 602 communicate the sensor data 608 to the surveillance client 136. As with sensor data acquisition, the DCSs 602 can communicate the sensor data 608 continuously or in response to an event, such as a push event (originating with the DCSs 602) or a poll event (originating with the surveillance client 136).

Continuing with the process 600, the surveillance client 136 monitors 610 the location by processing the received sensor data 608. For instance, in some examples, the surveillance client 136 executes one or more image processing routines. These image processing routines may include any of the image processing routines described above with reference to the operation 606. By distributing at least some of the image processing routines between the DCSs 602 and surveillance clients 136, some examples decrease power consumed by battery-powered devices by off-loading processing to line-powered devices. Moreover, in some examples, the surveillance client 136 may execute an ensemble threat detection process that utilizes sensor data 608 from multiple, distinct DCSs 602 as input. For instance, in at least one example, the surveillance client 136 will attempt to corroborate an open state received from a contact sensor with motion and facial recognition processing of an image of a scene including a window to which the contact sensor is affixed. If two or more of the three processes indicate the presence of an intruder, the threat score is increased and or a break-in event is declared, locally recorded, and communicated. Other processing that the surveillance client 136 may execute includes outputting local alerts (e.g., in response to detection of particular events and/or satisfaction of other criteria) and detection of maintenance conditions for location-based devices, such as a need to change or recharge low batteries and/or replace/maintain the devices that host the DCSs 602. Any of the processes described above within the operation 610 may result in the creation of location data that specifies the results of the processes.

Continuing with the process 600, the surveillance client 136 communicates the location data 614 to the surveillance service 128 via one or more ingress messages 612 to the transport services 126. As with sensor data 608 communication, the surveillance client 136 can communicate the location data 614 continuously or in response to an event, such as a push event (originating with the surveillance client 136) or a poll event (originating with the surveillance service 128).

Continuing with the process 600, the surveillance service 128 processes 616 received location data. For instance, in some examples, the surveillance service 128 executes one or more routines described above with reference to the operations 606 and/or 610. Additionally or alternatively, in some examples, the surveillance service 128 calculates a threat score or further refines an existing threat score using historical information associated with the location identified in the location data and/or other locations geographically proximal to the location (e.g., within the same zone improvement plan (ZIP) code). For instance, in some examples, if multiple break-ins have been recorded for the location and/or other locations within the same ZIP code within a configurable time span including the current time, the surveillance service 128 may increase a threat score calculated by a DCS 602 and/or the surveillance client 136. In some examples, the surveillance service 128 determines, by applying a set of rules and criteria to the location data 614, whether the location data 614 includes any reportable events and, if so, communicates an event report 618A and/or 618B to the monitor interface 130 and/or the customer interface 132. A reportable event may be an event of a certain type (e.g., break-in) or an event of a certain type that satisfies additional criteria (e.g., movement within a particular zone combined with a threat score that exceeds a threshold value). The event reports 618A and/or 618B may have a priority based on the same criteria used to determine whether the event reported therein is reportable or may have a priority based on a different set of criteria or rules.

Continuing with the process 600, the monitor interface 130 interacts 620 with monitoring personnel through, for example, one or more GUIs. These GUIs may provide details and context regarding one or more reportable events.

Continuing with the process 600, the customer interface 132 interacts 622 with at least one customer through, for example, one or more GUIs. These GUIs may provide details and context regarding one or more reportable events.

It should be noted that the processing of sensor data and/or location data, as described above with reference to the operations 606, 610, and 616, may be executed by processors disposed within various parts of the system 100. For instance, in some examples, the DCSs 602 execute minimal processing of the sensor data (e.g., acquisition and streaming only) and the remainder of the processing described above is executed by the surveillance client 136 and/or the surveillance service 128. This approach may be helpful to prolong battery runtime of location-based devices. In other examples, the DCSs 602 execute as much of the sensor data processing as possible, leaving the surveillance client 136 and the surveillance service 128 to execute only processes that require sensor data that spans location-based devices and/or locations. This approach may be helpful to increase scalability of the system 100 with regard to adding new locations.

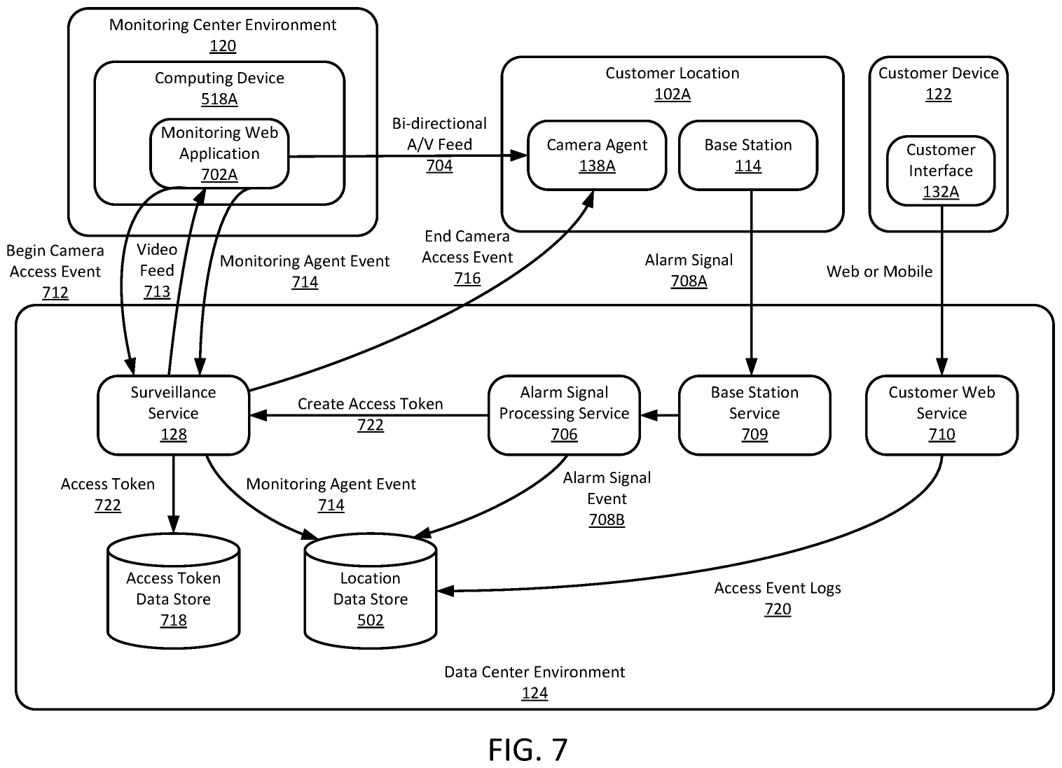

FIG. 7 shows further aspects of the monitoring center environment 120 of FIGS. 1 and 5, one of the customer devices 122 of FIG. 1, one of the monitored locations 102A of FIG. 1, and the data center environment 124 of FIGS. 1 and 5, in accordance with an example of the present disclosure. As discussed above, the monitoring center environment 120 includes one or more computing devices, such as computing device 518A. The computing device 518A is configured to execute one example of the monitoring interface 130—a monitoring web application 702A. The data center environment 124 includes the surveillance service 128 and the location data store 502, as well as an alarm signal processing service 706, a base station service 709, a customer web service 710 and an access token data store 718.

The monitoring web application 702A can be configured to perform several functions including remotely interoperating with and controlling equipment (e.g., location-based device), such as one or more cameras having video and audio capabilities, at the customer location 102A. For example, subject to certain constraints, the monitoring web application 702A can permit a monitoring service agent to access audio and/or video via the camera agent 138A located and operating at the customer location 102A, such as for viewing recorded or live video feeds from one or more cameras and/or for bi-directional audio and/or video 704 between the monitoring center environment 120 and the customer location 102A. Additionally, the monitoring web application 702A can be configured to cause events associated with remote monitoring to be logged such that the customer can review actions taken by the monitoring agent during a remote monitoring session. The constraints, discussed in further detail below, are provided to increase the customer's confidence that the monitoring service is acting in accordance with the customer's expectations regarding data privacy and security.

An example use case is as follows. Initially, the base station 114 generates an alarm signal 708A. The alarm signal 708A is received (e.g., via a transport service 126 as described above) by the base station service 709 in the data center environment 124, which is remote from the customer location 102A and connected via the Internet or another telecommunications system. The base station service 709 processes the alarm signal 708A to generate an alarm event 708B and passes the alarm event 708B to the alarm signal processing service 706. The alarm signal processing service 706 also stores information related to the alarm signal 708A and the alarm event 708B in the location data store 502, such as the location, time, and other data associated with the alarm signal 708A and the alarm event 708B (such as which sensor generated the alarm signal 708A that triggered the alarm event 708B).

The alarm signal processing device 706 creates an access token 722, which is used by the surveillance service 128 to securely access the video feed from the camera(s) at the customer location 102A so that the monitoring web application 702A can gain temporary access to the cameras (or other location-based devices) at the customer location 102A. The access token is stored in an access token data store 718. The access token is a single-use, time-limited token that expires after it is used to access the video feed or after the time limit expires, whichever comes first.

In response to reception of the alarm event 708B, the alarm signal processing service 706 calls the monitoring web application 702A in the monitoring center environment 120, which displays a list of cameras installed at the customer location 102A. The monitoring service agent can select, via the monitoring web application 702A, which camera to view. The monitoring web application 702A then issues a begin camera access event 712 to the surveillance service 128, which in turn provides a video feed 713 from the selected camera to the monitoring web application 702A using a valid access token. This allows the monitoring web application 702A to access and output the video and audio feeds from the customer location 102A to obtain further information and enable a monitoring agent to speak to someone located near the camera (e.g., via the speaker 454 and microphone 456), such as described with respect to code 408 in FIG. 4A. For example, the monitoring agent may view the video stream via the monitoring web application 702A to determine whether an intruder is present or whether the customer inadvertently triggered the alarm (e.g., a false alarm). For instance, a false alarm can occur if the customer resets the base station 114 within 60 seconds of alarm initiation or otherwise indicates to the monitoring agent (e.g., via a text message or telephone call) that the alarm is to be canceled. If the monitoring agent determines that a false alarm occurred, or that no further action needs to be taken, the monitoring agent can cause the monitoring web application 702A to end the video feed. In this instance, the monitoring web application 702A sends a monitoring agent event 714 to the surveillance service 128, which in turn sends an end camera access event 716 to the camera agent 138A at the customer location 102A. In response to receiving the end camera access event 716, the camera agent 138A terminates the video feed to the monitoring web application 702A. In addition, the surveillance service 128 logs the monitoring agent event 714 in the location data store 502, which is accessible to the user via the customer interface 132A (e.g., a web interface or a mobile device interface). In some examples, the monitoring agent event 714 can represent other actions taken by the monitoring service agent (e.g., an agent interacted via camera event), such as when the agent remotely activates a speaker and microphone in the camera to speak and listen to a person near the camera. Other events can represent actions such as viewing the video feed, recording the video feed, initiating bi-directional audio communications with the at least one camera, terminating or muting the bi-directional audio communications with the at least one camera, canceling an alarm, and dispatching law enforcement or emergency services to the monitored location.

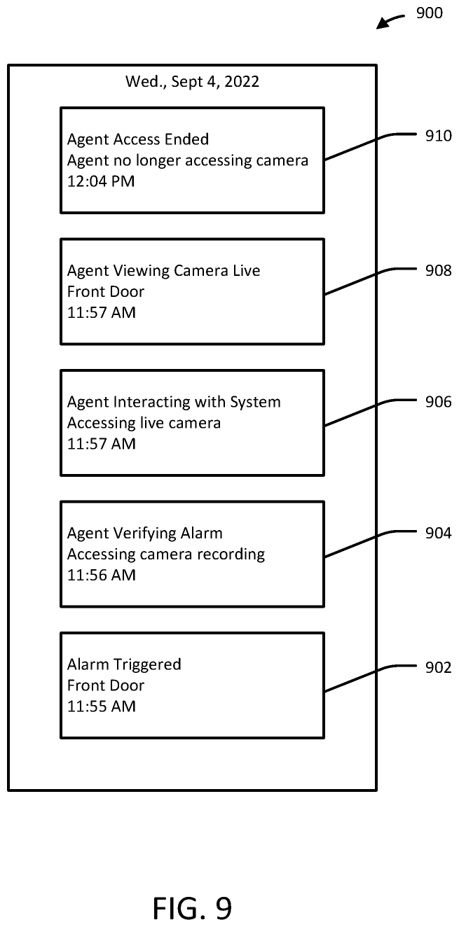

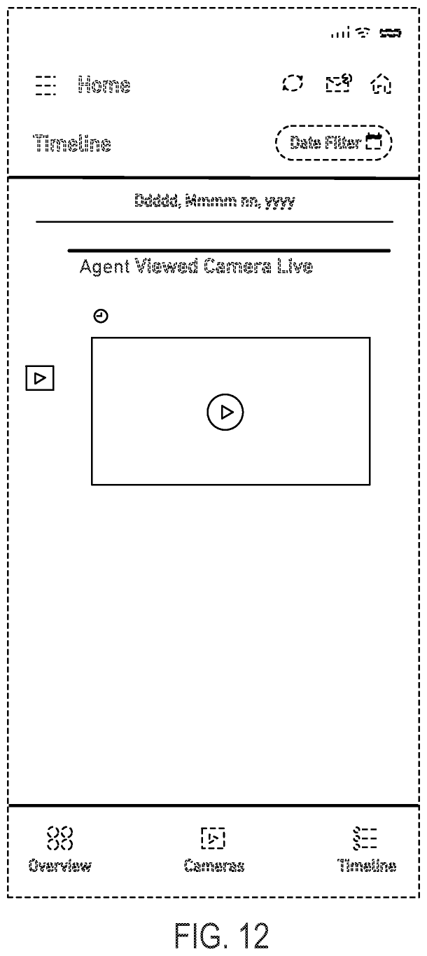

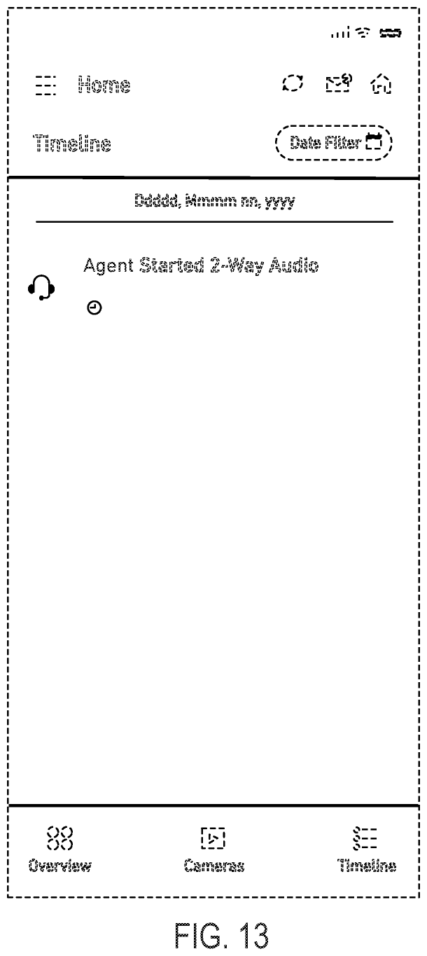

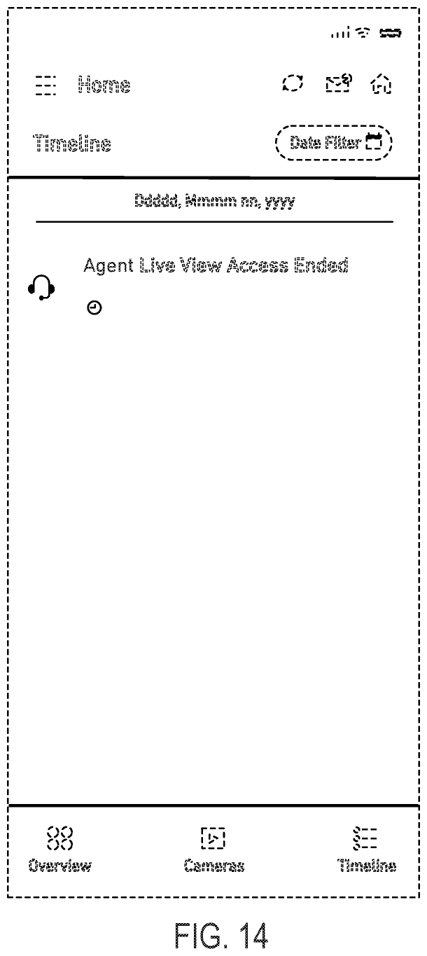

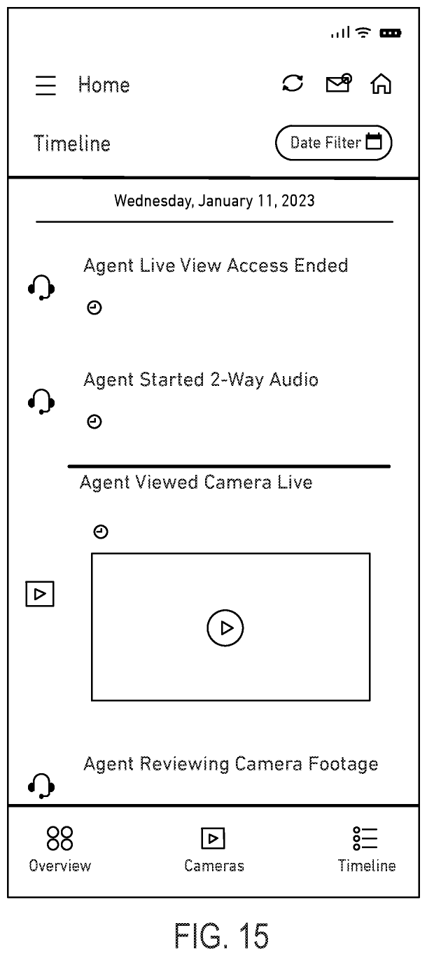

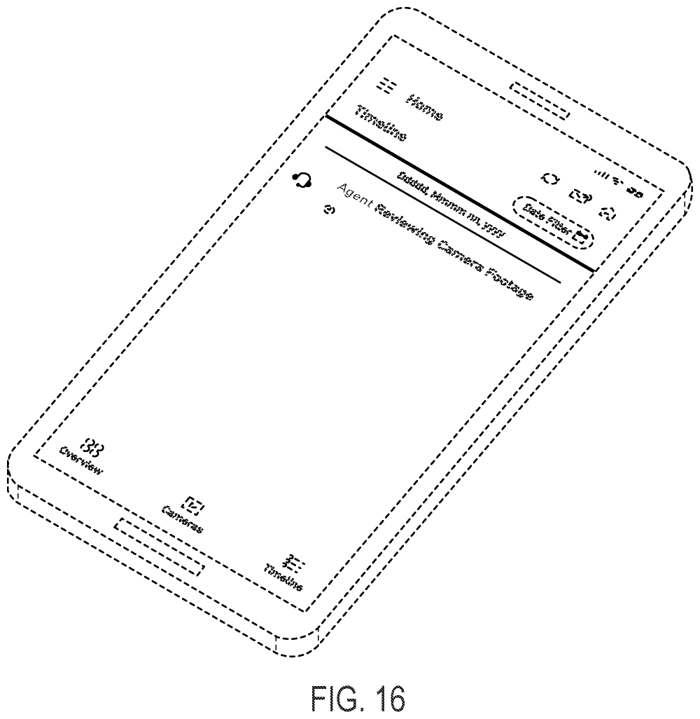

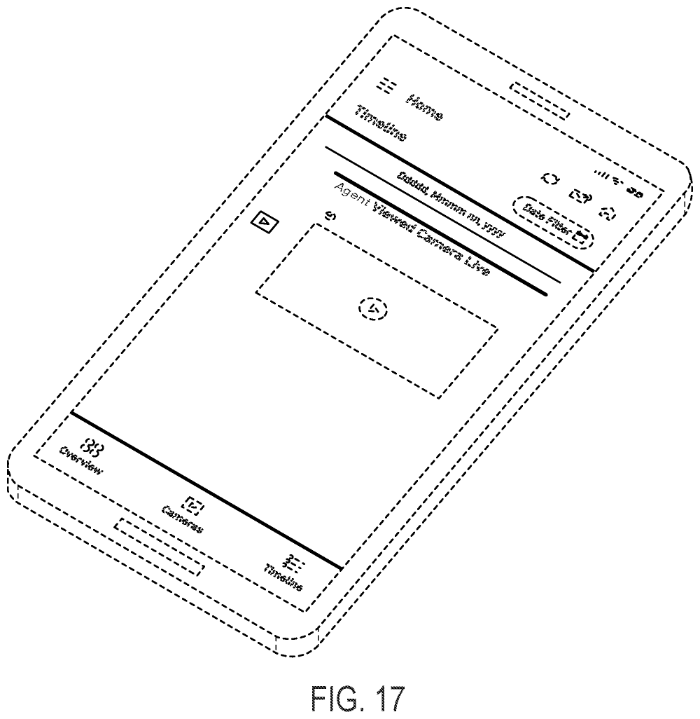

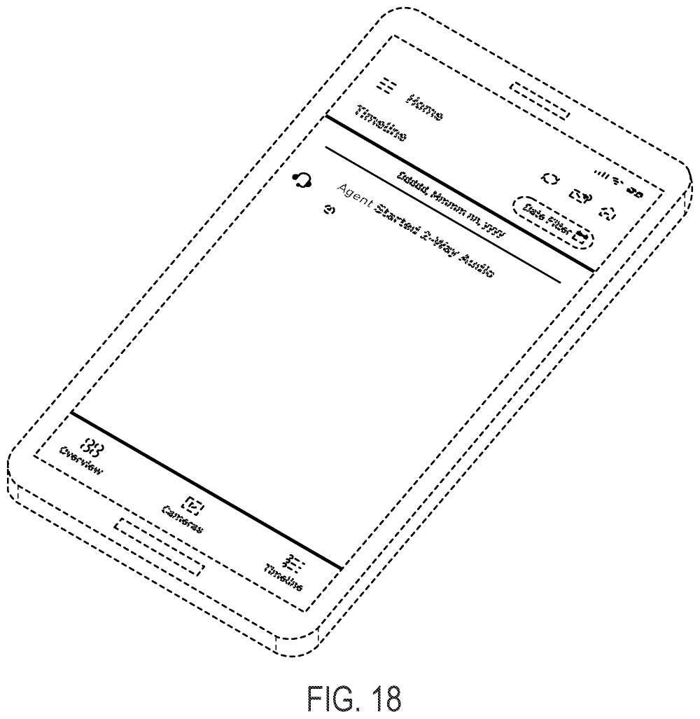

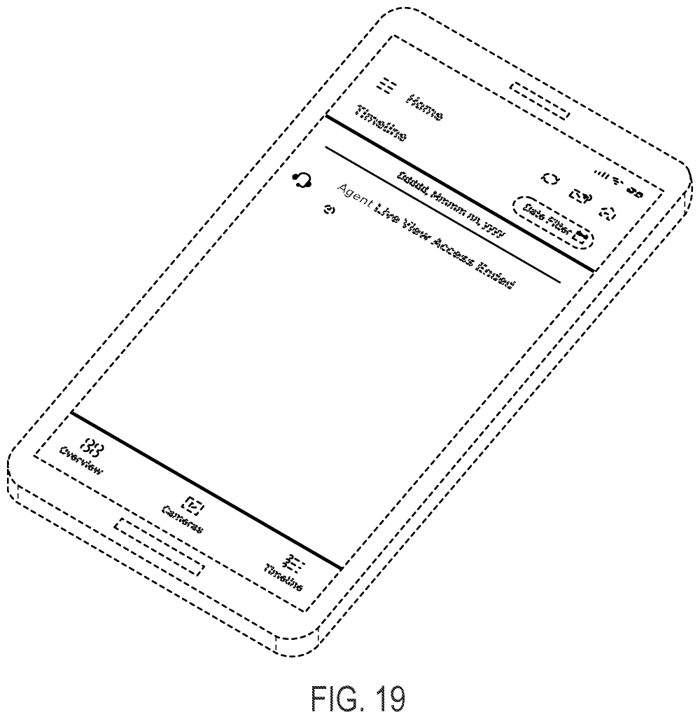

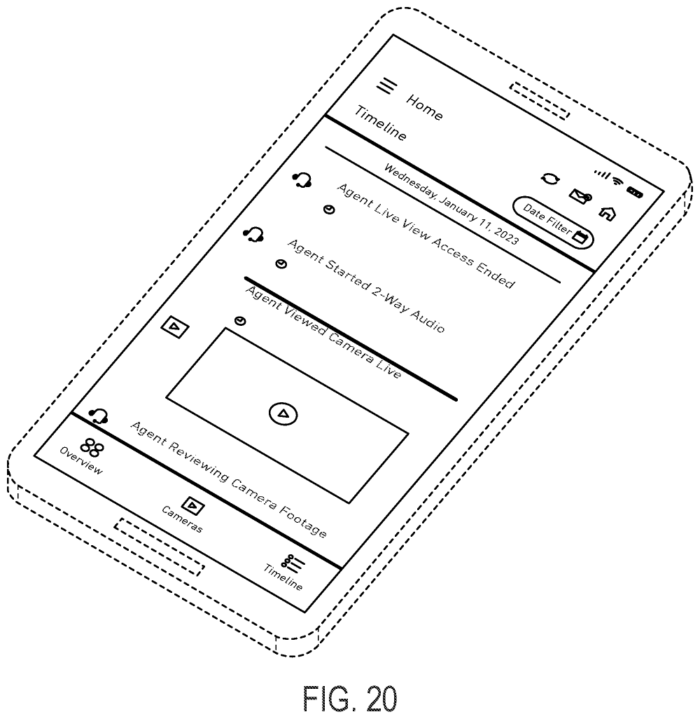

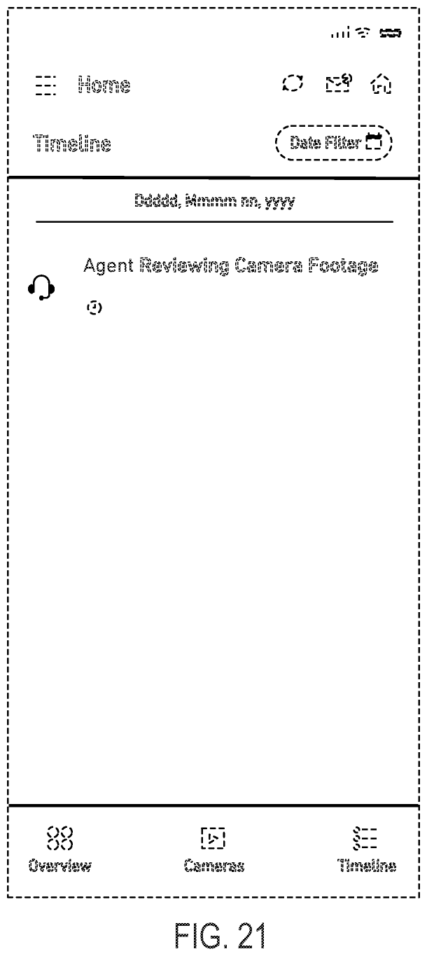

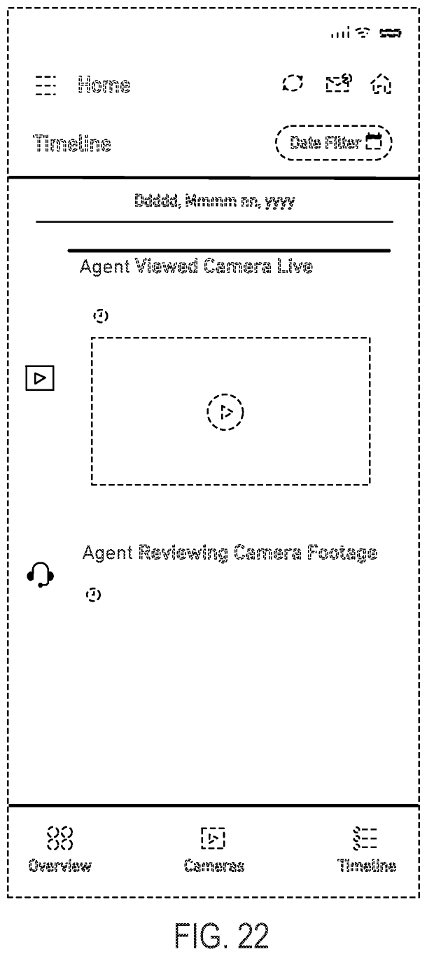

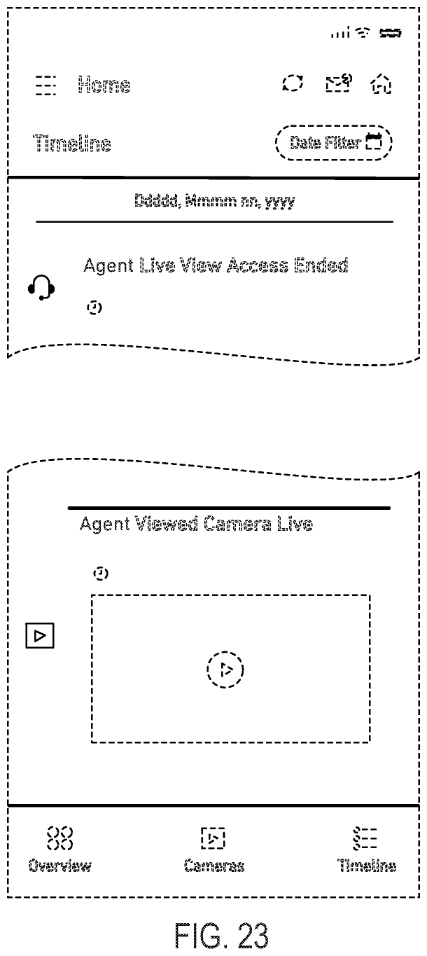

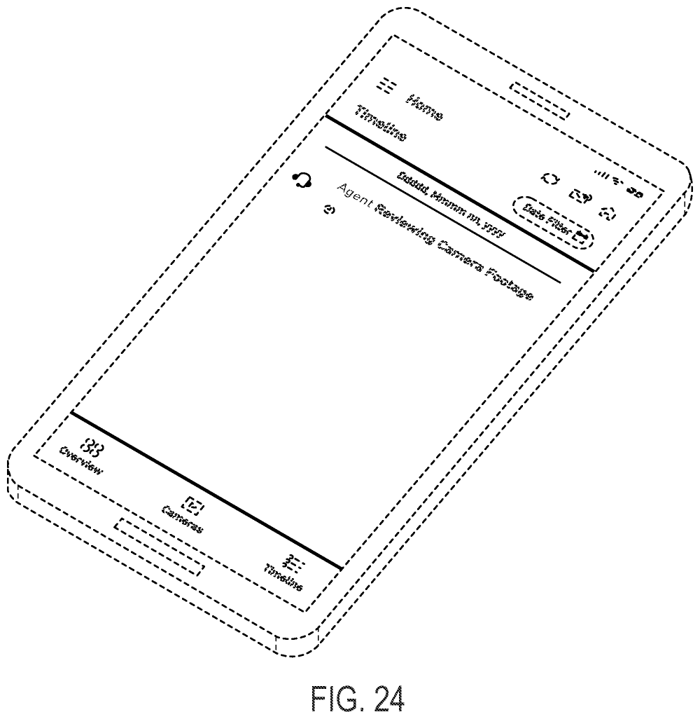

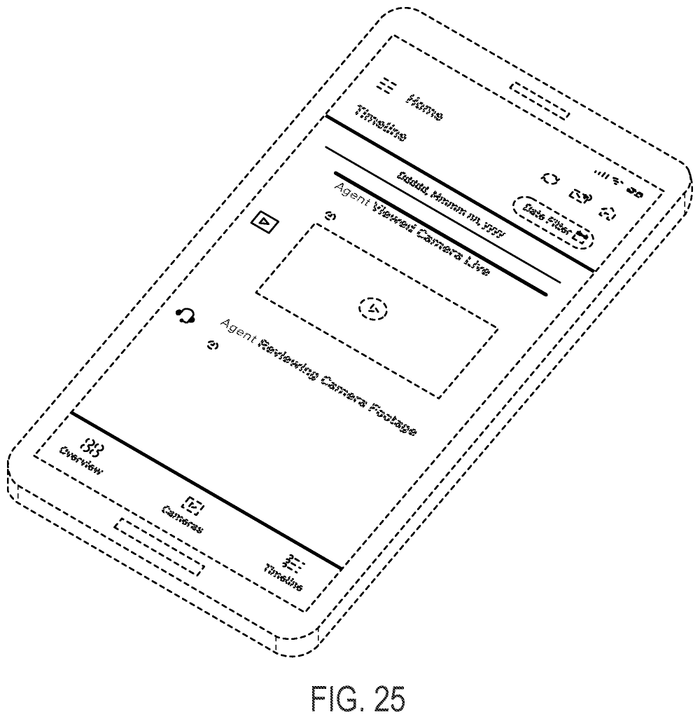

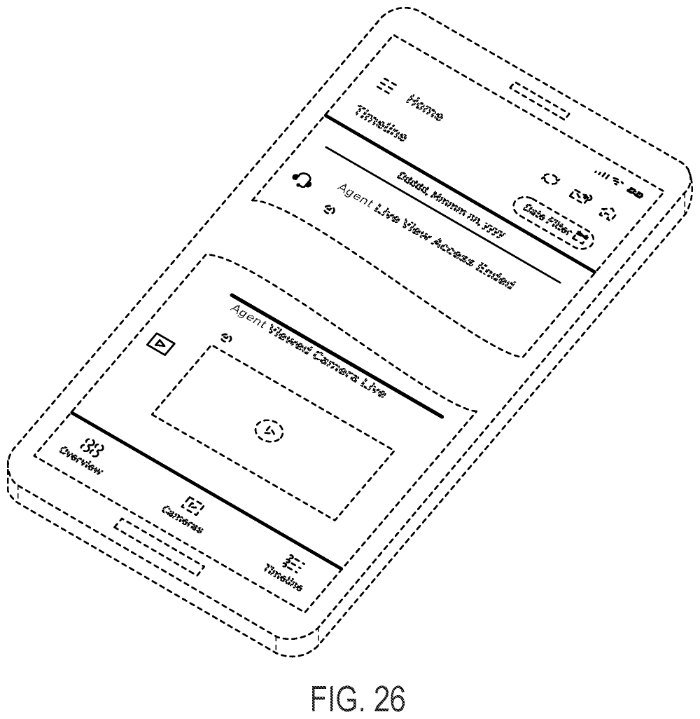

In general, activities performed by the monitoring agent using the monitoring web application 702A will generate events that are transmitted from the monitoring web application 702A to the surveillance service 128 and stored in the location data store 502. The customer can access the logged events 720 stored in the location data store 502 via the customer interface 132A of the customer device 122, such as shown in FIGS. 9 and 11-26. For example, the logged events can be accessed by the user and displayed via a scrolling graphical user interface of the customer interface 132A.

It should be noted that, in some implementations, the customer web service 710 and the alarm signal processing service 706 are integrated with or otherwise a part of the surveillance service 128. Similarly, the access token data store 718 can be housed within the location data store 502, in some examples. Additionally or alternatively, in some examples, the base station service 709 is integrated with or otherwise a part of the event listener 510 described above with reference to FIG. 5 and the alarm processing service 706 is an example of an event handler with which the event listener 510 interoperates.

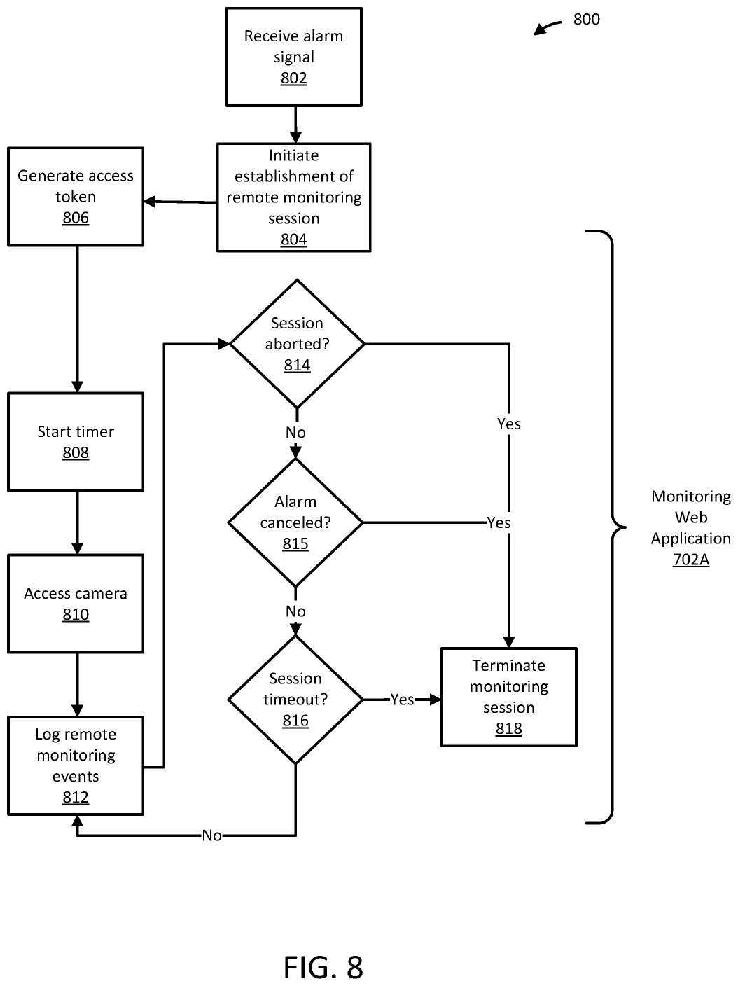

FIG. 8 is a flow diagram of a process 800 for security system event monitoring, in accordance with an example of the present disclosure. The process 800 can be executed, in some examples, by a security system (e.g., the security system 100 of FIG. 1). More specifically, in some examples, at least a portion of the process 800 is executed by the monitoring center environment 120 (e.g., the monitoring web application 702a, the base station service 709, the alarm signal processing service 706, the surveillance service 128, and the customer web service 710 of FIG. 7).

The process 800 begins by the base station service receiving 802 an alarm signal, such as the alarm signal 708A of FIG. 7, transmitted by the base station 114 or any location-based device configured to communicate data from a monitored location. For example, the alarm signal 708A can be generated by the camera agent 138A in response to detecting motion or the presence of a person or object in the video generated by the image capture device 110. The alarm signal 708A is processed by the base station service and passed to the alarm signal processing service. The alarm signal processing service generates an alarm event, such as the alarm event 708B and initiates establishment 804 of a remote monitoring session. The remote monitoring session is one during which, for example, a monitoring service agent using the monitoring web application 702A in the monitoring center environment 120 gains temporary remote access to the image capture device 110. Such access includes the ability to view video from the image capture device 110 and communicate bi-directionally therewith.

As discussed above, there are some constraints on the remote monitoring session. One constraint is security. For instance, an access token can be generated by the alarm signal processing service through interoperations with (e.g., API calls to) a surveillance service (e.g., the surveillance service 128) for use by the monitoring web application 702A to access the image capture device 110 (e.g., to retrieve video data from a camera). The access token is a single-use credential provided to the monitoring web application 702A for accessing the image capture device 110 during the remote monitoring session. The token improves the security of the system by limiting access by the monitoring service to the image capture device 110 and any other data generated by the system (including the video data) for the duration of the remote monitoring session. After the remote monitoring session ends, the token expires and access to the image capture device 110 is terminated. To this end, the process 800 further includes generating 806 an access token.

Another constraint is time. For instance, a time limit (e.g., 5, 10, or 20 minutes, etc.) can be imposed on the length of the remote monitoring session to limit how long the monitoring service has access to the image capture device 110. Such a time limit permits the monitoring service agent enough time to resolve alarm events while limiting the invasion of the customer's privacy. To this end, the process 800 further includes starting (e.g., by the monitoring web application and/or the surveillance service) a timer 808, which is used to limit the length of the remote monitoring session.

The method 800 further includes accessing (e.g. by the monitoring web application) the camera 810 using the access token generated for the remote monitoring session. The method 800 further includes logging 812 (e.g., by the surveillance service) remote monitoring events. For example, individual events associated with the remote monitoring session can be logged in a timeline format including information about the nature of the event and the time at which the event occurred. Examples of such events include alarm signals, initiation and termination of camera access by the monitoring service, initiation and termination of third-party audio access, and any other monitoring service agent actions taken during the remote monitoring session.

In some examples, there are three conditions that will end the remote monitoring session. One condition occurs if the monitoring service agent manually terminates the remote monitoring session via the monitoring web application 702A. The monitoring web application 702A may detect the manual termination using a variety of techniques. For instance, in one example, the monitoring web application 702A may detect a full reset of one or more location-based devices and respond thereto by terminating the remote monitoring session. Additionally or alternatively, the monitoring web application 702A may detect a request to terminate the remote monitoring session initiated by another process involved in provision of the remote monitoring session and respond thereto by terminating the remote monitoring session.

Another condition that will end the remote monitoring session occurs if the customer manually cancels the alarm via the customer device 122 or a location-based device. For instance, in some examples, the customer web service 710 may receive a text message specifying a “c” from the customer device 122 in response to a text message indicating the occurrence of an alarm. Alternatively or additionally, the customer web service 710 may receive a message from the customer interface 132A requesting cancelation of an alarm. Alternatively or additionally, the surveillance service 128 may receive a message from a location-based device requesting cancelation of an alarm. It should be noted that, to effectively end the remote session, some implementations will require any cancelation message be received within a configuration amount of time from receipt of an alarm signal (e.g., 60 seconds, 2 minutes, 3 minutes, etc.)

Still another condition occurs if the timer expires. If the monitoring service agent manually terminates the session 814, the customer cancels the alarm 815, or if the session times out 816, then the method 800 includes terminating 818 the remote monitoring session.

In some examples, the monitoring agent can cause, by interacting with monitoring web application, the live camera video feed, or a portion thereof, to be recorded for future review. Alternatively or additionally, the monitoring web application may initiate automatic recordation of the live camera video feed for future use. Such recordings can be automatically deleted after a configurable period of time, such as one hour, one day, one week, 30 days, one month, one year, etc. This configurable period of time may be stored within a retention policy that applies to all such recordings. Automatically deleting videos that have been recorded during a remote monitoring session helps increase customer confidence that the videos will not be accessible for longer than needed to immediately respond to an alarm event. Alternatively or additionally, in some examples, the recordings may be deleted in response to reception of user input requesting the same via the customer interface 132A.

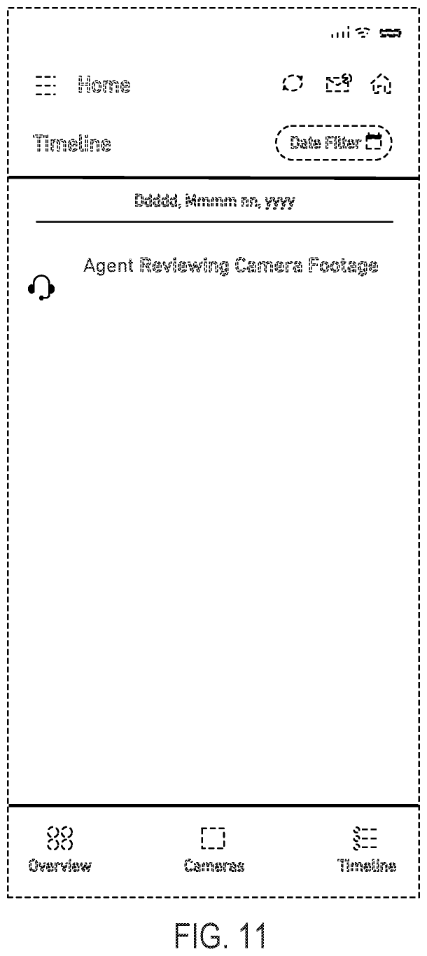

FIG. 9 shows a graphical user interface 900 for displaying remote monitoring events that have been logged according to the process 800 of FIG. 8, in accordance with an example of the present disclosure. In this example, the graphical user interface 900 includes several event controls arranged in reverse chronological order according to the time at which the respective events visualized within each event control occurred. Event control 902 represents an alarm triggered event; event control 904 represents an agent viewing alarm event; event control 906 represents an agent interacting with system event; event control 908 represents a begin camera access event; and event control 910 represents an end camera access event. The begin camera access event control 908 can, in some examples, include a link to audiovisual content, such as a link 912 to camera video beginning at the same time as the begin camera access event. The link 912, when selected by the user, causes the video to be retrieved or played within the graphical user interface 900 or via another modality (e.g., download video to local storage, play video in a web browser, etc.). Individually and in combination, the event controls 902-910, among others, are used by the user to monitor how and when the monitoring service agent is accessing the security system and cameras, which provides operational transparency that helps the user gain trust in the monitoring service agent. The event controls 902-910 can include text, images, and videos. FIGS. 11-26 show other examples of graphical user interfaces for displaying remote monitoring events that have been logged according to the process 800 of FIG. 8, in accordance with examples of the present disclosure.

Turning now to FIG. 10, a computing device 1000 is illustrated schematically. As shown in FIG. 10, the computing device includes at least one processor 1002, volatile memory 1004, one or more interfaces 1006, non-volatile memory 1008, and an interconnection mechanism 1014. The non-volatile memory 1008 includes code 1010 and at least one data store 1012.

In some examples, the non-volatile (non-transitory) memory 1008 includes one or more read-only memory (ROM) chips; one or more hard disk drives or other magnetic or optical storage media; one or more solid state drives (SSDs), such as a flash drive or other solid-state storage media; and/or one or more hybrid magnetic and SSDs. In certain examples, the code 1010 stored in the non-volatile memory can include an operating system and one or more applications or programs that are configured to execute under the operating system. Alternatively or additionally, the code 1010 can include specialized firmware and embedded software that is executable without dependence upon a commercially available operating system. Regardless, execution of the code 1010 can result in manipulated data that may be stored in the data store 1012 as one or more data structures. The data structures may have fields that are associated through colocation in the data structure. Such associations may likewise be achieved by allocating storage for the fields in locations within memory that convey an association between the fields. However, other mechanisms may be used to establish associations between information in fields of a data structure, including through the use of pointers, tags, or other mechanisms.

Continuing the example of FIG. 10, the processor 1002 can be one or more programmable processors to execute one or more executable instructions, such as a computer program specified by the code 1010, to control the operations of the computing device 1000. As used herein, the term “processor” describes circuitry that executes a function, an operation, or a sequence of operations. The function, operation, or sequence of operations can be hard coded into the circuitry or soft coded by way of instructions held in a memory device (e.g., the volatile memory 1004) and executed by the circuitry. In some examples, the processor 1002 is a digital processor, but the processor 1002 can be analog, digital, or mixed. As such, the processor 1002 can execute the function, operation, or sequence of operations using digital values and/or using analog signals. In some examples, the processor 1002 can be embodied in one or more application specific integrated circuits (ASICs), microprocessors, digital signal processors (DSPs), graphics processing units (GPUs), neural processing units (NPUs), microcontrollers, field programmable gate arrays (FPGAs), programmable logic arrays (PLAs), or multicore processors. Examples of the processor 1002 that are multicore can provide functionality for parallel, simultaneous execution of instructions or for parallel, simultaneous execution of one instruction on more than one piece of data.

Continuing with the example of FIG. 10, prior to execution of the code 1010 the processor 1002 can copy the code 1010 from the non-volatile memory 1008 to the volatile memory 1004. In some examples, the volatile memory 1004 includes one or more static or dynamic random-access memory (RAM) chips and/or cache memory (e.g. memory disposed on a silicon die of the processor 1002). Volatile memory 1004 can offer a faster response time than a main memory, such as the non-volatile memory 1008.

Through execution of the code 1010, the processor 1002 can control operation of the interfaces 1006. The interfaces 1006 can include network interfaces. These network interfaces can include one or more physical interfaces (e.g., a radio, an ethernet port, a USB port, etc.) and a software stack including drivers and/or other code 1010 that is configured to communicate with the one or more physical interfaces to support one or more LAN, PAN, and/or WAN standard communication protocols. The communication protocols can include, for example, TCP and UDP among others. As such, the network interfaces enable the computing device 1000 to access and communicate with other computing devices via a computer network.

The interfaces 1006 can include graphical and/or text-based user interfaces. For instance, in some examples, the user interfaces include user input and/or output devices (e.g., a keyboard, a mouse, a touchscreen, a display, a speaker, a camera, an accelerometer, a biometric scanner, an environmental sensor, etc.) and a software stack including drivers and/or other code 1010 that is configured to communicate with the user input and/or output devices. As such, the user interfaces enable the computing device 1000 to interact with users to receive input and/or render output. This rendered output can include, for instance, one or more GUIs including one or more controls configured to display output and/or receive input. The input can specify values to be stored in the data store 1012. The output can indicate values stored in the data store 1012.

Continuing with the example of FIG. 10, the various features of the computing device 1000 described above can communicate with one another via the interconnection mechanism 1014. In some examples, the interconnection mechanism 1014 includes a communications bus.

Various inventive concepts may be embodied as one or more methods, of which examples have been provided. The acts performed as part of a method may be ordered in any suitable way. Accordingly, examples may be constructed in which acts are performed in an order different than illustrated, which may include performing some acts simultaneously, even though shown as sequential acts in illustrative examples.

Descriptions of additional examples follow. Other variations will be apparent in light of this disclosure.

Example 1 is a method comprising establishing, by remote computing device and in response to an alarm signal, a remote session with a camera, the remote session enabling a remote user to access video and audio data of the camera, and the access including streaming of video data for a location monitored by the camera and bi-directional communications between persons at the location and the remote user; generating, during the remote session, one or more events representative of actions of the remote user to access the camera; and providing notifications about the one or more events to a client device, the notifications including an indication that the remote user accessed the camera.

Example 2 includes the subject matter of Example 1 and further comprises causing the one or more events to be displayed to a user via a graphical user interface.

Example 3 includes the subject matter of either Example 1 or Example 2 and further comprises starting a timer in response to establishing the remote session.

Example 4 includes the subject matter of Example 3 and further comprises terminating the remote session in response to a timeout of the timer.

Example 5 includes the subject matter of Example 4, wherein terminating the remote session occurs in response to a manual termination of the remote session by a monitoring agent.

Example 6 includes the subject matter of any of Examples 1 through 5 and further comprises generating an access token in response to establishing the remote session, wherein accessing the video data requires the access token.

Example 7 includes the subject matter of Example 6, wherein the access token expires in response to terminating the remote session.

Example 8 includes the subject matter of any of Examples 1 through 7 and further includes logging, to a data store and in response to an action taken by a monitoring agent with respect to the camera, a monitoring agent event.

Example 9 includes the subject matter of Example 8, wherein the action includes one or more of verifying an alarm condition exists, viewing the video data, recording the video data, initiating bi-directional audio communications with the camera, terminating or muting the bi-directional audio communications with the camera, canceling an alarm, and dispatching law enforcement or emergency services to the location.

Example 10 is a system of computing devices. The system includes at least one computing device. The at least one computing device includes a memory; and at least one processor coupled with the memory and configured to establish, in response to an alarm signal, a remote session with a camera, the remote session enabling a remote user to access video and audio data of the camera, and the access including streaming of video data for a location monitored by the camera and bi-directional communications between persons at the location and the remote user; generate, during the remote session, one or more events representative of actions of the remote user to access the camera; and provide notifications about the one or more events to a client device, the notifications including an indication that the remote user accessed the camera.

Example 11 includes the subject matter of Example 10, wherein the at least one processor is further configured to cause the one or more events to be displayed to a user via a graphical user interface.

Example 12 includes the subject matter of either Example 10 or Example 11, wherein the at least one processor is further configured to start a timer in response to establishing the remote session, and to terminate the remote session in response to a timeout of the timer.

Example 13 includes the subject matter of Example 12, wherein the at least one processor is further configured to terminate the remote session in response to a manual termination of the remote session.

Example 14 includes the subject matter of any of Examples 10 through 13, wherein the at least one processor is further configured to generate an access token in response to beginning the remote session, wherein accessing the video data requires the access token.

Example 15 includes the subject matter of Example 14, wherein the access token expires in response to ending the remote session.

Example 16 includes the subject matter of any of Examples 10 through 15, wherein the at least one processor is further configured to log, to a data store and in response to an action taken by a monitoring agent with respect to the camera, a monitoring agent event.

Example 17 is directed to one or more computer readable media storing sequences of instructions executable to report security system events. The sequences of instructions include instructions to receive an alarm signal from a device configured to communicate data generated by at least one camera in a monitored location; begin, in response to receiving the alarm signal, a remote monitoring session during which a monitoring agent gains temporary access to video generated by the at least one camera; access, by the monitoring agent and during the remote monitoring session, a video feed via the at least one camera; log, to a user-accessible log and in response to accessing the video feed, a begin camera access event; end the remote monitoring session; and log, to the user-accessible log and in response to ending the remote monitoring sessions, an end camera access event.

Example 18 includes the subject matter of Example 17, wherein the sequences of instructions further comprise instructions to cause the begin camera access event, the end camera access event, or both to be displayed to a user via a graphical user interface.

Example 19 includes the subject matter of either Example 17 or Example 18, wherein the sequences of instructions further comprise instructions to start a timer in response to beginning the remote monitoring session, and to end the remote monitoring session in response to a timeout of the timer.

Example 20 includes the subject matter of any of Examples 17 through 19, wherein the sequences of instructions further comprise instructions to generate an access token in response to beginning the remote monitoring session, wherein accessing the video feed requires the access token, and wherein the access token expires in response to ending the remote monitoring session.

Example 21 includes the subject matter of any of Examples 17 through 20, wherein the sequences of instructions further comprise instructions to initiate bi-directional audio communications with the at least one camera; log, to the user-accessible log and in response to initiating the bi-directional audio communications, a begin bi-directional audio communications event; and cause the begin bi-directional audio communications event to be displayed to a user via a graphical user interface.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

Examples of the methods and systems discussed herein are not limited in application to the details of construction and the arrangement of components set forth in the following description or illustrated in the accompanying drawings. The methods and systems are capable of implementation in other examples and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, components, elements or acts of the systems and methods herein referred to in the singular can also embrace examples including a plurality, and any references in plural to any example, component, element or act herein can also embrace examples including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” can be construed as inclusive so that any terms described using “or” can indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

Having described several examples in detail, various modifications and improvements will readily occur to those skilled in the art. Such modifications and improvements are intended to be within the scope of this disclosure. Accordingly, the foregoing description is by way of example only, and is not intended as limiting.

1. A method comprising:
establishing, by a remote computing device and in response to an alarm signal, a remote session with a camera, the remote session enabling a remote user to access, via a network connection, video and audio data of the camera, and the access including streaming of the video data for a location monitored by the camera and bi-directional communications between persons at the location and the remote user;
generating, during the remote session, an event representative of one or more actions of the remote user to access the camera; and
providing a notification about the event to a client device that is distinct from the camera, the notification indicating that the remote user accessed the video data for the location monitored by the camera.

2. The method of claim 1, further comprising causing the event to be displayed to a user via a graphical user interface.

3. The method of claim 1, further comprising starting a timer in response to establishing the remote session.

4. The method of claim 3, further comprising terminating the remote session in response to a timeout of the timer.

5. The method of claim 4, wherein terminating the remote session occurs in response to a manual termination of the remote session by a monitoring agent.

6. The method of claim 1, further comprising generating an access token in response to establishing the remote session, wherein accessing the video data requires the access token.

7. The method of claim 6, wherein the access token expires in response to terminating the remote session.

8. The method of claim 1, further comprising logging, to a data store and in response to an action taken by a monitoring agent with respect to the camera, a monitoring agent event.

9. The method of claim 8, wherein the action taken by the monitoring agent includes one or more of verifying an alarm condition exists, viewing the video data, recording the video data, initiating bi-directional audio communications with the camera, terminating or muting the bi-directional audio communications with the camera, canceling an alarm, and dispatching law enforcement or emergency services to the location.

10. A system of computing devices, the system comprising at least one computing device comprising:
a memory; and
at least one processor coupled with the memory and configured to:
establish, in response to an alarm signal, a remote session with a camera, the remote session enabling a remote user to access, via a network connection, video and audio data of the camera, and the access including streaming of the video data for a location monitored by the camera and bi-directional communications between persons at the location and the remote user;
generate, during the remote session, an event representative of one or more actions of the remote user to access the camera; and
provide a notification about the event to a client device that is distinct from the camera, the notification indicating that the remote user accessed the video data for the location monitored by the camera.

11. The system of claim 10, wherein the at least one processor is further configured to cause the event to be displayed to a user via a graphical user interface.

12. The system of claim 10, wherein the at least one processor is further configured to start a timer in response to establishing the remote session, and to terminate the remote session in response to a timeout of the timer.

13. The system of claim 12, wherein the at least one processor is further configured to terminate the remote session in response to a manual termination of the remote session.

14. The system of claim 10, wherein the at least one processor is further configured to generate an access token in response to beginning the remote session, wherein accessing the video data requires the access token.

15. The system of claim 14, wherein the access token expires in response to ending the remote session.

16. The system of claim 10, wherein the at least one processor is further configured to log, to a data store and in response to an action taken by a monitoring agent with respect to the camera, a monitoring agent event.

17. One or more non-transitory computer readable storage media storing sequences of instructions executable to report security system events, the sequences of instructions comprising instructions to:
receive an alarm signal from a device configured to communicate data generated by at least one camera in a monitored location;
begin, in response to receiving the alarm signal, a remote monitoring session during which a monitoring agent gains temporary access to video generated by the at least one camera;
access, by the monitoring agent and during the remote monitoring session, a video feed via the at least one camera;
log, to a user-accessible log and in response to accessing the video feed, a begin camera access event;
end the remote monitoring session; and
log, to the user-accessible log and in response to ending the remote monitoring sessions, an end camera access event.

18. The one or more non-transitory computer readable storage media of claim 17, wherein the sequences of instructions further comprise instructions to cause the begin camera access event, the end camera access event, or both to be displayed to a user via a graphical user interface.

19. The one or more non-transitory computer readable storage media of claim 17, wherein the sequences of instructions further comprise instructions to start a timer in response to beginning the remote monitoring session, and to end the remote monitoring session in response to a timeout of the timer.

20. The one or more non-transitory computer readable storage media of claim 17, wherein the sequences of instructions further comprise instructions to generate an access token in response to beginning the remote monitoring session, wherein accessing the video feed requires the access token, and wherein the access token expires in response to ending the remote monitoring session.

21. The one or more non-transitory computer readable storage media of claim 17, wherein the sequences of instructions further comprise instructions to:
initiate bi-directional audio communications with the at least one camera;
log, to the user-accessible log and in response to initiating the bi-directional audio communications, a begin bi-directional audio communications event; and
cause the begin bi-directional audio communications event to be displayed to a user via a graphical user interface.
